(19) United States
(12) Patent Application Publication
(10) Pub. No.: US 2008/0147558 A1
(43) Pub. Date: Jun. 19, 2008

(54) METHOD AND SYSTEM FOR PROVIDING PROSPECTIVE LICENSEES AND/OR PURCHASERS WITH ACCESS TO LICENSABLE MEDIA CONTENT

(76) Inventor: Robert Korbin Kraus, Los Angeles, CA (US)

Correspondence Address: ROBERT KORBIN KRAUS, 1450 RISING GLEN RD, LOS ANGELES, CA, 90069, US

(21) Appl. No.: 11/552,390

(22) Filed: Oct. 24, 2006

(51) Int. Cl. H04N 7/16

(52) U.S. Cl. 705/59; 725/25; 713/150

(57) ABSTRACT

Techniques and technologies are provided to facilitate licensing/purchasing of licensable media content, such as, copyrighted musical composition(s) and sound recording(s). In one exemplary implementation of these techniques and technologies, a web-based method is provided which helps a prospective licensee/purchaser in finding and licensing/purchasing licensable media content can, such as, copyrighted musical composition(s) and sound recording(s). When the licensable audio file comprises a copyrighted musical composition, the agreement to license/purchase the licensable audio file for use with the video file may comprise a synchronization license, a master use license and/or a mechanical license.

### BACKGROUND

The present invention relates to licensing and/or purchasing of media content, including audio content such as sound effects and music and video content, to a third party for use in commercial projects, such as audio-visual productions, and more particularly to a web based system for facilitating licensing and/or purchasing of such media content.

In the context of licensable audio content, as opposed to other types of licensable media content, when a songwriter composes a musical composition, copyright ownership to the words and music comprising the musical composition generally vests in the composer, unless either (a) they are employed by a music production company for the purpose of writing musical compositions, in which case the employer generally retains copyright ownership of such compositions or (b) the composer has written the musical composition pursuant to a written agreement specifying that the composition was created as a “work made for hire” to be owned by a third party. Also, when a musical artist (or band) records a song, the copyright to the sound recording generally rests with the party in charge of producing the recording, frequently either the recording artist or the record label to which the artist is signed. The copyright for a musical composition is separate and distinct from the copyright to a sound recording and may be owned by the same party or different parties depending upon the particular facts and circumstances surrounding the creation of the copyrighted works. Composers and musical artists typically perfect their copyright interest in a musical composition or sound recording by registering the work with the U.S. Library of Congress (in the United States) or the appropriate copyright registration agency in the country in which they reside.

Among the exclusive rights granted to copyright owners under the Copyright Act of 1976 are the right to distribute, display, publicly perform and reproduce the copyrighted work, and the right to grant licenses to third parties for the exploitation of such rights. In the entertainment and advertising industries, such as television, radio, motion picture, television commercial advertisements and corporate video production companies, etc., producers of such audio-visual programs often seek to incorporate pre-recorded and copyrighted audio content, such as music, within their programs and television commercials. When copyrighted audio content is used in an audio-visual production, such as a television program, motion picture or television commercial, the audio content will not only be performed publicly (when the program or television commercial is exhibited or broadcast), the audio content may also be reproduced if the program is exploited via “home video” distribution within DVD's, video tapes and digital downloads available for purchase online. Because the rights to publicly perform and reproduce copies of copyrighted works are among the bundle of exclusive rights enjoyed by copyright owners, the film or television producers must first obtain the copyright owner's permission before incorporating a musical composition and sound recording into an audio-visual production by securing an appropriate license to do so or by purchasing the composition and recording outright. The licensing of songs for audio-visual works involves two separate copyrights: (1) the copyright to the underlying musical composition, which is usually owned by either the composer (or the music publisher who has obtained from the composer the right to own or control the composition); and 2) the copyright to the specific sound recording of the composition, which is usually owned by either the recording artist or a record company for whom the artist performed on the recording as a “work made for hire.”

When a music supervisor (a person charged with the responsibility for securing copyrighted audio content on a television program or film) decides on or selects a copyrighted sound recording they would like to use in their commercial production, for instance, the music supervisor must acquire appropriate license(s) from the copyright owners of both the sound recording and the underlying musical composition. Said licenses can include, for example, a master use license (to use a copyrighted sound recording, often referred to as a “master” license), a mechanical license (to “reproduce” the underlying musical composition—generally required if copies of a television program or film will be made available for sale to the general public), a synchronization license (to use a copyrighted musical composition), etc.

Permission to use the sound recording and underlying musical composition, and the license/purchase fee to be charged to the production company producing the audio-visual program, are at the discretion of the copyright owners, so the composers, music publishers and record labels earn whatever can be negotiated for the use of the music within the program. In television program licensing deals, negotiation issues include, for example, the license fee, the type of media covered by the license (e.g., cable TV, network TV, home video, etc), the territory of the license (e.g., the U.S., North America, the world) and the term (e.g., length) of the license.

Business Models for Acquiring Licensable Media Content

Traditionally, one way producers would either purchase or acquire appropriate license(s) to licensable audio content, would be by consulting with second party vendors, such as a music production company, which either owns the copyrights to licensable audio content or represents the copyright holder. The second party vendor would provide the producers with access to a catalog of sound recordings and underlying musical compositions.

Other business models for licensing/purchasing licensable audio content are based on regular and direct communications between a music production company (or other entity authorized to represent the copyright holder) and the producer of an audio-visual production. In some cases, the producer (or their representative, etc.) can communicate (either directly or indirectly, for example, via e-mail) with a representative of the music production company and convey information about the audio content (e.g., music) they seek. In some cases, the producer (or their representative) provide the company with actual visual content for which the audio content is sought.

Many companies representing a library of copyright holders send audio tracks to their prospective clients on compact disks (CDs) which is difficult because they become dated very quickly. Because many CDs are sent out, a specific track could be sold and, hence, be unavailable, without the recipient knowing that another recipient has already purchased a particular audio track offered on that CD. The intended recipient (e.g., prospective client) reviewing the audio track may learn later that she/he will not be able to obtain the rights (e.g., buy or license) to that particular music track.

Selecting the appropriate audio content for use with a commercial audio-visual production can be a time consuming task especially from the perspective of the licensee/purchaser of that audio content. For example, a music supervisor for the commercial production may review dozens or sometimes hundreds of different pieces of audio content before narrowing his or her choices down to a few and eventually selecting a particular audio track to use in conjunction with their video or program. The process generally involves listening to many different pieces of audio content and auditioning it numerous times against particular video content. Moreover, even once a particular audio track has been selected, it is oftentimes a repetitive, trial-and-error process to precisely synchronize the particular audio track at a given location within the video track it is to be used in conjunction with. For example, this process can involve repeatedly starting and stopping the audio track at different points, and attempting to synchronize the audio content with a specific portion of the video content at precisely the right timing. Alternatively, the music production company might dub the video content supplied by the producer of the program multiple times on a video cassette, and then synchronize each potential recording to the video which is then sent out to the client for consideration.

Yet another problem is that although the music production company can identify a number of different pieces of audio content which the commercial producer may be potentially interested in licensing, in some cases, the commercial producer may need more time before making a final decision as to which specific audio content will be selected for licensing/purchasing. For instance, the music supervisor for the production may need input from other persons involved in making the final selection. In such cases, the music supervisor has to maintain a list of the different pieces of audio content which they think the commercial producer may be potentially interested in licensing/purchasing so that the different pieces of audio content are more easily accessed at a later time. In addition, the music supervisor may also need to maintain lists of different time points within a particular audio track which may be good starting points at which to begin synchronizing the audio content with the video content. In this situation, an already time-consuming task, can easily become even more time-consuming.

### BRIEF DESCRIPTION OF THE DRAWINGS

The systems and methods for use in providing licensable media content are further described with reference to the accompanying drawings in which

FIG. 1 provides a schematic diagram of an exemplary networked computing environment.

FIG. 2 is a schematic diagram of an exemplary network computing environment.

FIG. 3 is a flowchart showing exemplary techniques for synchronizing and/or auditioning a first licensable media file against a second media file to potentially license/sell the first licensable media file to a prospective licensee or purchaser; and

FIGS. 4-9 are screenshots of a browser displaying particular web pages served by a web page server of a server to a client.

### DETAILED DESCRIPTION

The following detailed description is merely exemplary in nature and is not intended to limit the invention or the application and uses of the invention. As used herein, the word “exemplary” means “serving as an example, instance, or illustration.” Any implementation described herein as “exemplary” is not necessarily to be construed as preferred or advantageous over other implementations. All of the implementations described below are exemplary implementation provided to enable persons skilled in the art to make or use the invention and are not intended to limit the scope of the invention which is defined by the claims. Furthermore, there is no intention to be bound by any expressed or implied theory presented in the preceding background, brief summary or the following detailed description.

Terminology

As used herein, the term “media player” refers to computer software for playing back media files. Most software media players support an array of media formats, including both audio and video files. As such, a “media player” can include functionality for executing (e.g., playing) audio and/or video files. Some media players focus only on executing audio files or video files, and are known as audio players or video players, respectively.

As used herein, the term “file format” refers to a particular way to encode information for storage in a computer file.

As used herein, the term “container format” refers a computer file format that can contain various types of data, compressed by means of standardized codecs. The container file is used to identify and interleave the different data types. Simpler container formats can contain different types of audio codecs, while more advanced container formats can support audio, video, subtitles, chapters, and meta-data (tags)—along with the synchronization information needed to play back the various streams together. Some containers are exclusive to audio: WAV (RIFF file format, widely used on Windows platform), and AIFF (AIFF file format, widely used on Mac OS platform). Other flexible containers can hold many types of audio and video, as well as other media. The most popular multi-media containers are: AVI (the obsolete standard Microsoft Windows container, also based on RIFF), MOV (standard QuickTime container), MPEG-2 transport stream (TS) (standard container for digital broadcasting) which typically contains multiple video and audio streams, and an electronic program guide, MP4 (standard container for the MPEG-4 multimedia portfolio), ASF (standard container for Microsoft WMA and WMV), RealMedia (a standard container for RealVideo and RealAudio), etc.

As used herein, the term “audio file” refers to a file which stores audio content in any known format. As used herein, the term “audio content” refers to organized audio signals stored in a digital format including, for example, music, a musical composition, a sound recording, a song, sounds or a sound design. An audio file format is a container format for storing audio data on a computer system. There are numerous formats for storing audio files. An audio file may have any known compression format, including, but not limited to, ISO/IEC, MPEG: MPEG-1 Layer III (known as MP3), MPEG-1 Layer II, 4-MP3 Database, UNIS Composer 669 Module, Six Channel Module, Eight Channel Module, Amiga OctaMed Mucis File, Amiga 8-Bit Sound File, Advanced Audio Coding (AAC) File, ABC Music Notation, ADPCM Compressed Audio File, WinAHX Tracker Module, Audio Interchange File (AIF) Format, Compressed Audio Interchange File (AIF), A-Law Compressed Sound Format, A-Law Compressed Sound Format, Adaptive Multi-Rate Codec, Monkey's Audio Lossless Audio File, Audio File, Compressed Audio File, Audio Visual Research File, GarageBand Project, CD Audio Track, Audition Loop, Creative Music Format, Cakewalk SONAR Project, OPL2 FM Audio File, OPL2 FM Audio File, Digital Speech Standard (DSS) File, Sony Digital Voice File, Eyemail Audio Recording, Farandole Composer Module, Free Lossless Audio Codec, FruityLoops Project, IC Recorder Sound File, Interchangeable File Format, Impulse Tracker Module, Karaoke MIDI File, Kinetic Music Project, Kinetic Project Template, Logic Audio Project, MP3 Playlist, MPEG-4 Audio Layer File, iTunes Audio Book, Protected AAC File, Monarch Audio File, Amiga MED Sound File, MIDI File, Synthetic Music Mobile Application Format, Amiga Music Module File MPEG Layer II Compressed Audio File, MPEG Layer 3 Audio File, MPEG Audio File, Musepack Audio File, Moving Picture Experts Group 3 Layer Audio, Mobile Phone Sound File, Memory Stick Voice File, MultiTracker Module, Napster Copyright-Secured Music File, Ogg Vorbis Compressed Audio File, Perfect Clarity Audio, Pulse Code Modulation, Panasonic Voice File, Real Audio Real Audio Media, Reason ReFill Sound Bank, Rich Music Format, RIFF MIDI (RMID) File, RealJukebox Format, ScreamTracker 3 Sound File, Secure Audio File, Sound Designer II File, Sample MIDI Dump Exchange, Sound File, SoundFont 2 Bank, Sound Forge Audio, Sibelius Score Standard MIDI File, SampleVision Audio Sample Format, Sound Clip, MIDI Song File, Synclavier Program File, Synclavier Sequence File, Synclavier Sound File, 8SVX Sound File, Signed Word Audio File, ShockWave Audio, Final Music System Tracker Module, Amiga THX Tracker Music File, PSP Audio File, TrueSpeech Audio File, Unsigned Byte Audio File, Olympus Voice Recording, Vocaltec Media File, Creative Labs Audio (Voice) File, Voyetra Voice File, VoxWare Audio, Ventrilo Audio Recording, Windows WAVE Sound File, Wave Sound File, Windows Media Audio Redirect, Windows Media Audio (WMA), Cakewalk Music Project, Extended Module Audio (EMA) File, Compressed eXtended MIDI file, etc. Though most audio file formats support only one audio codec, an audio file format may support multiple codecs, as AVI does.

As used herein, the term “licensable” file refers to a file which contains a copyrighted work, stored at a server (e.g., physically located at the server or externally connected to the server), which can be licensed and/or sold to another (e.g., the licensee or a representative of the licensee). In this context, the term “licensable” indicates that the sound recording and underlying musical composition comprising the audio file are capable of being licensed to or purchased by another, or are being offered to a third party for license or purchase. In this context, the term “third party” refers to a party other than: an owner or licensor of the copyrighted work (or copyrightable work) or a representative (e.g., agent) of the owner or licensor. Examples of potential licensees can include ad agencies and their clients, production companies, editors, producers, programmers, directors, and motion picture and television studios. In this context, the term “file” can refer to a media file, such as, an audio file, a video file or image file. When licensed, as opposed to purchased, the licensable file can be the subject of either a synchronization or synch license (as defined herein), a mechanical license and/or a “master use” and performance license (as defined herein).

As used herein, the term “licensable audio file” refers to an audio file which can be offered for license or sale to another (e.g., for incorporation into an audio-visual work). When licensed, a “licensable audio file” can be licensed for many different types of uses. For example, a “licensable audio file” can be licensed for: a soundtrack for motion picture production, trailer, preview, intro, outro or header; a soundtrack for television show production, trailer, preview, intro, outro or header; television and radio advertising content (for ads, intro or content); a soundtrack for radio broadcast production; backing music for an Internet Web site or webcast, podcast, webisode or other streamed content; a soundtrack for video game, electronic game and computer game (whether distributed online, CD-ROM, DVD or any other media); a soundtrack for software application (e.g., online, CD-ROM, DVD or any other media); music-on-hold (E.g., for music to play while someone is on-hold on the telephone); telephone ring tones; embedding in a toy or product for musical backing purposes; embedding in an electronic device for musical backing purposes; a sound effect or sample embedded in original music composition; a soundtrack for home video production; a soundtrack for student film, project film and other short video production; a theater production, competition, sporting event, etc.; corporate use in trade show, live performance, presentation, meeting or seminar; pre-production (i.e. evaluation mode only); and small business professional local use (massage, therapy, dance studios or similar).

As used herein, the term “video file” refers to a file comprising video content. As used herein, the term “video content” refers to moving pictures captured or recorded in a storage media using a known format (e.g., for viewing on television or as video clips on computer screens). The video file may have any known compression format, including, but not limited to, ISO/IEC; MPEG-1, MPEG-2, MPEG-4, MPEG-4/AVC, ITU-T: H261, H.262, H.263, H.264, SMPTE: VC-1, VP7, RealVideo, WMV, Indeo, MJPEG, Theora, or other formats.

As used herein, the term “licensable video file” refers to a video file that is being offered for license or sale to another (e.g., for incorporation into an audio-visual work).

As used herein, the term “master use license” refers to a license granted to a third party to incorporate a copyrighted sound recording (e.g., the “master” recording)within any project or production that will be publicly performed, displayed, broadcast, exhibited or reproduced. Licensing of an actual sound recording is different than the licensing of the underlying musical composition (e.g., the original words and music written by the songwriter) embodied in the sound recording. In the United States, for example, a master use license must be secured from the copyright holder of the sound recording, which is typically either the musical artist that performed on the sound recording or the record company that produced the sound recording, or a designated agent or representative of the copyright holder.

As used herein, the term “mechanical license” refers to a license that grants to a licensee the right to reproduce and distribute copyrighted musical compositions to the public within CDs, records, tapes, DVD's and other stored digital formats (e.g., Internet digital downloads) for the uses identified therein, which may include commercial uses, non-commercial uses, marketing and advertising purposes, etc., all in consideration of an agreed-upon per unit royalty fee. In the event that the licensor and licensee cannot agree upon a royalty fee, the licensee is entitled to invoke the provisions of the Copyright Act of 1976, as amended, and compel the licensor to grant to licensee a mechanical license upon the terms and conditions as set forth in the Copyright Act. A mechanical license is only applicable to a musical composition, and is not used to obtain permission to reproduce a sound recording. Therefore, it is not unusual for a mechanical license to be combined with a synchronization license at the request of the licensor or licensee.

As used herein, the term “synchronization license” or “synch license” refers to a license granted to a licensee for the right to incorporate the underlying musical composition within a production or program and to publicly perform the composition. Synchronization licensing, also known as “synch licensing” or “sync licensing,” is the licensing of an original copyrighted musical composition for use in combination with visual images such as motion pictures, television shows, television commercials, film or television leasers or trailers, videos, video games, webisodes, podcasts, internet programs or productions, digital mobile content or any other audio-visual production, software and other visual imagery. A synch license give the licensee the right to use the musical composition in time synchronization with a visual image. In the United States, a synch license must be obtained from the copyright holder of the musical composition, which is usually either the songwriter or composer of the subject composition, or a music publishing company, publishing administrator or other representative or agent of the songwriter or composer that has obtained the right to grant licenses for the subject composition on the songwriter's or composer's behalf.

For example, filmmakers (or any other producer of an audio-visual production or program) that would prefer to use copyrighted audio content within their production, such as, for example, the copyrighted sound recording of the song “Satisfaction,” written and recorded by the Rolling Stones, must obtain both a synch license from the songwriters (or their publishing company), and a master use and performance license from the Rolling Stones' record company on order to use the copyrighted sound recording (e.g., music). If, however, the filmmaker (or other producer or production company) prefers to use a new recording of “Satisfaction” to be recorded by musicians hired by the filmmaker (called a “cover” recording), then only a synch license from the songwriters of the musical composition “Satisfaction” is necessary since the filmmaker is not using the copyrighted recording of the song. In other words, a filmmaker or producer will always need to obtain a synch license any time they desire to incorporate a copyrighted musical composition within their program or production, but they do not need to obtain a master use license unless they also want to obtain the right to a copyrighted sound recording of the musical composition (in this example, the sound recording of “Satisfaction” as performed by the Rolling Stones). Once a synch license is obtained, the filmmaker or producer has the right to incorporate the musical composition within their audio-visual program or production. Since the right to publicly perform copyrighted musical compositions is a separate right for which the producer of the program must obtain a license, the songwriter or composer (and/or the songwriter or composer's music publishing company, publishing administrator, representative or agent) will designate a public performance rights society, such as, in the United States, BMI, ASCAP or SESAC, to collect public performance royalties on their behalf from all entities which exhibit or broadcast the program or production (i.e., movie theaters, broadcast networks, restaurants, bars, stadiums, etc.).

As used herein, the term “time code” refers to a sequence of numeric codes generated at regular intervals by a timing system. Time codes are used extensively to synchronize multiple distinct recordings. Audio and video content can be synchronized using the Society of Motion Picture and Television Engineers (SMPTE) time code standard. The SMPTE time code standard associates each video frame with a unique set of numbers which can be thought of as an “address” represented as information indicating, for example, a measure of time, such as hours, minutes, seconds and frames. That is, each frame of a film corresponds to an exact SMPTE time written as HH:MM:SS:FF. For example “03:23:14:05” means 3 hours, 23 minutes, 14 seconds and 5 frames. Time code information can be transmitted in a variety of ways. The most common method is to use an audio tone that can be recorded onto an analog tape track or carried over analog audio cables. This type of time code is called Linear Time Code (LTC), because most traditional video formats carry analog audio information in a linear track on the edge of the video tape, whereas video is stored in diagonal bands through the middle of the tape. A vertical Interval Time Code (VITC) is yet another way of transmitting time code information by embedding a time code between video frames of the video signal. That is, the time code is placed in sections of the video signal which are not displayed on the screen. This time between frames is called a “vertical blanking interval.”

Overview

This “Overview” is provided to introduce a selection of concepts in a simplified form that are further described below. This “Overview” is not intended to identify key features or essential features of the claimed subject matter, nor is it intended to limit the scope of the claimed subject matter.

Techniques and technologies are provided to facilitate licensing/purchasing of licensable media content, such as, copyrighted musical composition(s) and sound recording(s). In one exemplary implementation of these techniques and technologies, a web-based method is provided which helps a prospective licensee/purchaser in finding and licensing/purchasing licensable media content, such as, copyrighted musical composition(s) and sound recording(s). According to this web-based method, a licensable audio file stored on a storage medium at a server can be selected by a prospective licensee/purchaser (or by another person operating the client computer, such as, a representative or agent of the prospective licensee/purchaser). The licensable audio file can be loaded (e.g., downloaded from the server) into an audio player module, and a video file can be loaded from a client computer into a video player module coupled to the audio player module by an interface. In one implementation, the audio player module and the video player module can be part of a multimedia player module which can be executed at the server. In another implementation, the audio player module and the video player module can be part of a multimedia player module which can be downloaded from the server to the client computer.

The prospective licensee/purchaser (or other person such operating the client computer) can use the audio player module and the video player module to audition the licensable audio file against the video file. Auditioning the licensable audio file against the video file can include, for example, displaying playback of the licensable audio file on the audio player module, displaying playback of the video file on the video player module, and synchronizing the playback of the licensable audio file to the playback of the video file. Synchronizing the licensable audio file to the video file can include, for example, starting playback of the licensable audio file on the audio player module at a first start time, and starting playback of the video file on the video player module at a second start time, where the first start time is offset from the second start time by a predetermined amount equal to a difference between the first start time and the second start time. For example, the first start time may comprise a first time code, and the second start time may comprise an initial start time of the video file. Alternatively, the first start time may comprise an initial start time of the licensable audio file, and the second start time may comprise a second time code.

The prospective licensee/purchaser (or other person operating the client computer) can then decide whether to license/purchase the licensable audio file for use with the video file. If a prospective licensee/purchaser decides to license or purchase the licensable audio file for use with the video file, then the licensee/purchaser can enter into an agreement with the licensor to license or purchase the licensable audio file for use with the video file. When the licensable audio file comprises a copyrighted musical composition and a copyrighted sound recording, the agreement to license/purchase the licensable audio file for use with the video file may comprise a synchronization license, a master use license and/or a mechanical license. The synchronization license grants the licensee the right to incorporate the copyrighted musical composition within a commercial production (e.g., grants the licensee the right to use the copyrighted musical composition in timed synchronization with visual images in an audio-visual production). The master use license grants the licensee the right to incorporate a copyrighted sound recording (e.g., the “master” recording) within a commercial production that will be publicly performed, displayed, broadcast, exhibited or reproduced. The mechanical license grants the licensee the rights to reproduce and distribute the copyrighted musical composition as part of the commercial production if, for instance, the production will be reproduced and distributed (e.g., as DVDs).

A web-based system is also provided comprising a server configured to store a licensable audio file (e.g., a copyrighted musical composition being offered to a prospective licensee/purchaser for use with the video file), a client computer configured to store a video file, and a Graphical User Interface (GUI). When the licensable audio file is a copyrighted musical composition and copyrighted sound recording, the copyrighted musical composition is being offered to a prospective licensee by way of a synchronization license granting the licensee the right to incorporate the copyrighted musical composition in combination (e.g., timed synchronization) with visual images in an audio-visual production, and/or a mechanical license that grants the licensee the rights to reproduce and distribute the copyrighted musical composition, and the copyrighted sound recording is being offered to a prospective licensee by way of a master use license granting the licensee the right to incorporate an perform the copyrighted sound recording within the audio-visual production.

The GUI comprises a display comprising an audio player user interface (APUI) configured to display playback of the licensable audio file, a video player user interface (VPUI) configured to display playback of the video file, a user interface selection device and a synchronization engine configured to synchronize the playback of the licensable audio file to the playback of the video file. The user interface selection device is designed to allow a user to select the licensable audio file stored on the second storage medium at the server, to load the licensable audio file for playback on the APUI, to load the video file from the client computer for playback on the VPUI and to audition the licensable audio file against the video file. The synchronization engine is configured to start playback of the licensable audio file at a first start time (e.g., a first time code or an initial start time of the licensable audio file), and to start playback of the video file at a second start time (e.g., an initial start time of the video file or a second time code), and wherein the first start time is offset from the second start time by a redetermined amount (e.g., a difference between the first start time and the second start time).

In an exemplary implementation of these techniques and technologies, a Web-based audio search engine is provided which has, among other features, video synchronization capabilities used in conjunction with licensable music for advertising, film, promos, TV, etc. The disclosed techniques and technologies can provide a prospective licensee/purchaser with a convenient Web-based environment for auditioning and/or synchronizing licensable music against video and vice-versa. The disclosed techniques and technologies can allow for better and faster creative output by eliminating the guesswork of determining which piece of licensable music works best with a particular video—thereby saving all involved time and money. Furthermore, an up-to-date website keeps information fresh and accurate, thus eliminating the problem agencies have with auditioning music that is ultimately unavailable for whatever reason. They are always able to check the status of an audio file immediately and it will be accurate.

Exemplary Networked Environments

The disclosed techniques and technologies can be implemented in connection with any computer or other client or server device, which can be deployed as part of a computer network. In this regard, the disclosed techniques and technologies pertain to any computer system or environment having any number of memory or storage units, and any number of applications and processes occurring across any number of storage units or volumes, which may be used in connection with processes in accordance with the disclosed techniques and technologies. The disclosed techniques and technologies can apply to an environment with server computers and client computers deployed in a network environment having remote or local storage.

Software may be described in the general context of computer-executable instructions, such as program modules, being executed by one or more computers, such as client workstations, servers or other devices. Generally, program modules include routines, programs, objects, components, data structures and the like that perform particular tasks or implement particular abstract data types. Typically, the functionality of the program modules may be combined or distributed as desired in various embodiments.

Moreover, those skilled in the art will appreciate that the invention may be practiced with other computer system configurations and protocols. Other well known computing systems, environments, and/or configurations that may be suitable for use with the invention include, but are not limited to, personal computers (PCs), server computers, hand-held or laptop devices, multi-processor systems, microprocessor-based systems, network PCs, minicomputers, mainframe computers and the like.

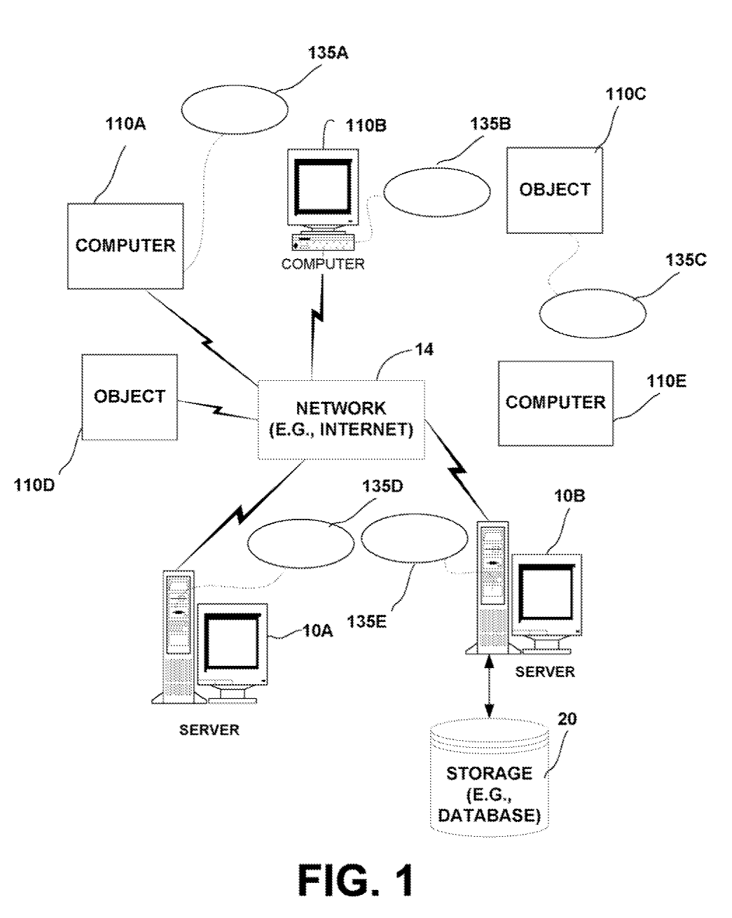

FIG. 1 provides a schematic diagram of an exemplary networked computing environment. The computing environment comprises computing objects 10A, 10B, etc. and computing objects or devices 110A, 110B, 110C, etc. An object, such as 110C, may be hosted on another computing device 10A, 10B, etc. or 110A, 110B, etc. The exemplary networked computing environment is commonplace in homes, offices, enterprise-wide computer networks, intranets and the Internet. These objects may comprise programs, methods, data stores, programmable logic, etc. The objects may comprise portions of the same or different devices such as audio/video devices, personal computers, etc. Each object can communicate with another object by way of the communications network 14. This network may itself comprise other computing objects and computing devices that provide services, and may itself represent multiple interconnected networks.

There computing environment is supported by a variety of systems, components, and network configurations. For example, computing systems may be connected together by wired or wireless systems, by local networks or widely distributed networks (e.g., the Internet or other infrastructure which encompasses many different networks). The Internet can be described as a system of geographically distributed remote computer networks interconnected by computers executing networking protocols that allow users to interact and share information over the network(s).

Thus, the network infrastructure enables network topologies such as client/server, peer-to-peer, or hybrid architectures. A “client” refers to a member of a class or group that uses the services of another class or group to which it is not related. Thus, in computing, a client can refer to a process, i.e., roughly a set of instructions or tasks, that requests a service provided by another program. The client process utilizes the requested service without having to “know” any working details about the other program or the service itself. A “server” is typically a remote computer system accessible over a remote or local network, such as the Internet. The client process may be active in a first computer system, and the server process may be active in a second computer system, communicating with one another over a communications medium, thus providing distributed functionality and allowing multiple clients to take advantage of the information-gathering capabilities of the server. Any software objects utilized may be distributed across multiple computing devices or objects. In a client/server architecture, a client is usually a computer that accesses shared network resources provided by another computer, e.g., a server. In the example of FIG. 1, computers 110A, 110B, etc. can be thought of as clients and computers 10A, 10B, etc. can be thought of as the server. A server 10A, 10B, etc. maintains the data that is then replicated in the client computers 110A, 110B, etc., although any computer can be considered a client, a server, or both, depending on the circumstances.

Client(s) and server(s) communicate with one another utilizing the functionality provided by protocol layer(s) used in conjunction with a network such as the Internet. The Internet commonly refers to the collection of networks and gateways that utilize the Transmission Control Protocol/Internet Protocol (TCP/IP) suite of protocols, which are well-known in the art of computer networking. The HyperText Transfer Protocol (HTTP) is a common protocol that is used in conjunction with the World Wide Web (WWW), or “the Web.” Typically, a computer network address such as an Internet Protocol (IP) address or other reference such as a Universal Resource Locator (URL) can be used to identify the server or client computers to each other. The network address can be referred to as a URL address. Communication can be provided over a communications medium, e.g., client(s) and server(s) may be coupled to one another via TCP/IP connection(s) for high-capacity communication.

Thus, FIG. 1 illustrates an exemplary networked environment, with a server in communication with client computers via a network/bus, in which the present invention may be employed.

In more detail, a number of servers 10A, 10B, etc., are interconnected via a communications network/bus 14, which may be a LAN, WAN, intranet, the Internet, etc., with a number of client or remote computing devices 110A, 110B, 110C, 110D, 110E, etc., such as a portable computer, handheld computer, thin client, and the like.

In a network environment in which the communications network/bus 14 is the Internet, for example, the servers 10A, 10B, etc. can be Web servers with which the clients 110A, 110B, 110C, 110D, 110E, etc. communicate via any of a number of known protocols such as HTTP. Servers 10A, 10B, etc. may also serve as clients 110A, 110B, 110C, 110D, 110E, etc. Communications may be wired or wireless, where appropriate. Client devices 110A, 110B, 110C, 110D, 110E, etc. may or may not communicate via communications network/bus 14, and may have independent communications associated therewith. Each client computer 110A, 110B, 110C, 110D, 110E, etc. and server computer 10A, 10B, etc. may be equipped with various application program modules or objects 135 and with connections or access to various types of storage elements or objects, across which filed or data streams may be stored or to which portion(s) of files or data streams may be downloaded, transmitted or migrated. Any one or more of computers 10A, 10B, 110A, 110B, etc. may be responsible for the maintenance and updating of a database 20 or other storage element, such as a database or memory 20 for storing data processed according to the invention. Thus, the present invention can be utilized in a computer network environment having client computers 110A, 110B, etc. that can access and interact with a computer network/bus 14 and server computers 10A, 10B, etc. that may interact with client computers 110A, 110B, etc. and other like devices, and databases 20.

FIG. 1 thus illustrates an example of a suitable computing system environment in which the invention may be implemented, although as made clear above, the computing system environment is only one example of a suitable computing environment and is not intended to suggest any limitation as to the scope of use or functionality of the invention. Neither should the computing environment be interpreted as having any dependency or requirement relating to any one or combination of components illustrated in the exemplary operating environment.

Exemplary Computing Environment

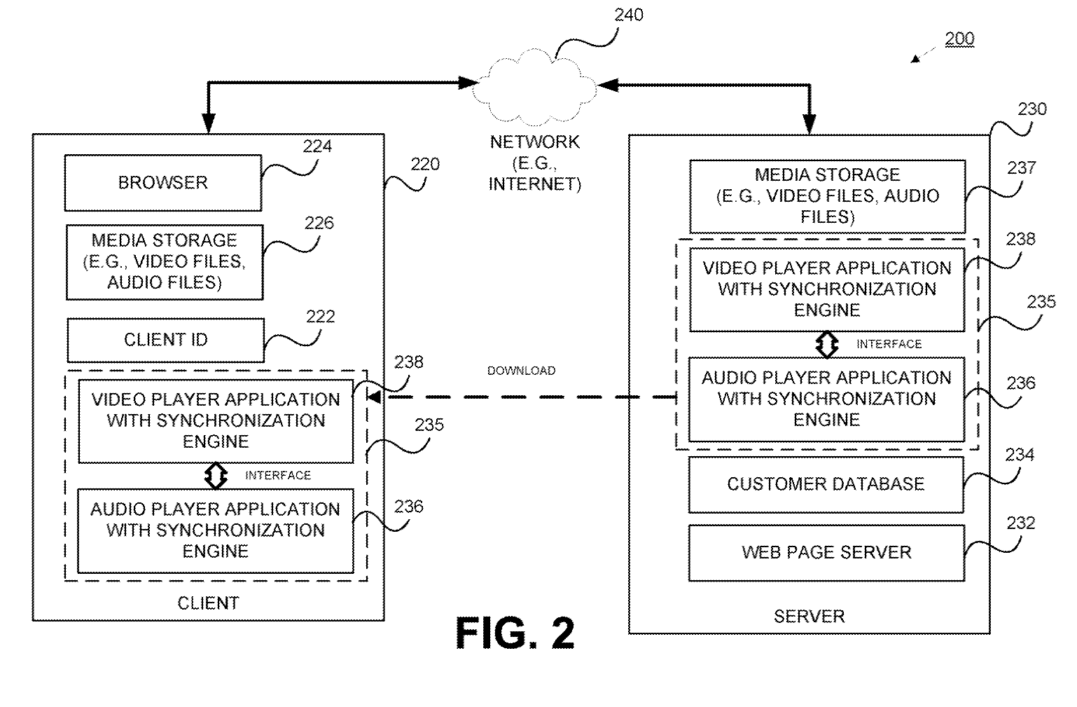

FIG. 2 is a schematic diagram of an exemplary network computing environment 200. The network computer environment 200 comprises a client 220 coupled to a server 230 via a network 240. The client 220 and server 230 communicate with each other via the network 240. It will be appreciated that the network connections shown are exemplary and other means of establishing a communications link between the computers may be used. Moreover, in one exemplary implementation, the network 240 may comprise, for example, the Internet.

In one exemplary implementation, the client 220 comprises a number of modules, for example, a client identifier 222, a browser application 224, a media storage unit 226 and optionally a media player application 235 which can be downloaded to the client 220, for example, from the server 230 or other remote sources. The media player application 235 comprises an audio player application 236 and a video player application 238 which can communicate with each other over an interface. Other components of client 220 computer, which are not explicitly shown, may include, but are not limited to, a processing unit, a system memory, and a system bus that couples various system components including the system memory to the processing unit, a display device and other peripheral output devices such as speakers and a printer, etc. Moreover, a client 220 computer typically includes a variety of computer readable media. Computer readable media can be any available media that can be accessed by client 220 computer and includes both volatile and nonvolatile media, removable and non-removable media. By way of example, and not limitation, computer readable media may comprise computer storage media and communication media. Computer storage media includes both volatile and nonvolatile, removable and non-removable media implemented in any method or technology for storage of information such as computer readable instructions, data structures, program modules or other data. Computer storage media includes, but is not limited to, RAM, ROM, EEPROM, flash memory or other memory technology, CDROM, digital versatile disks (DVD) or other optical disk storage, magnetic cassettes, magnetic tape, magnetic disk storage or other magnetic storage devices, or any other medium which can be used to store the desired information and which can be accessed by client 220 computer. Communication media typically embodies computer readable instructions, data structures, program modules or other data in a modulated data signal such as a carrier wave or other transport mechanism and includes any information delivery media. The term “modulated data signal” means a signal that has one or more of its characteristics set or changed in such a manner as to encode information in the signal. By way of example, and not limitation, communication media includes wired media such as a wired network or direct-wired connection, and wireless media such as acoustic, RF, infrared and other wireless media. Combinations of any of the above should also be included within the scope of computer readable media.

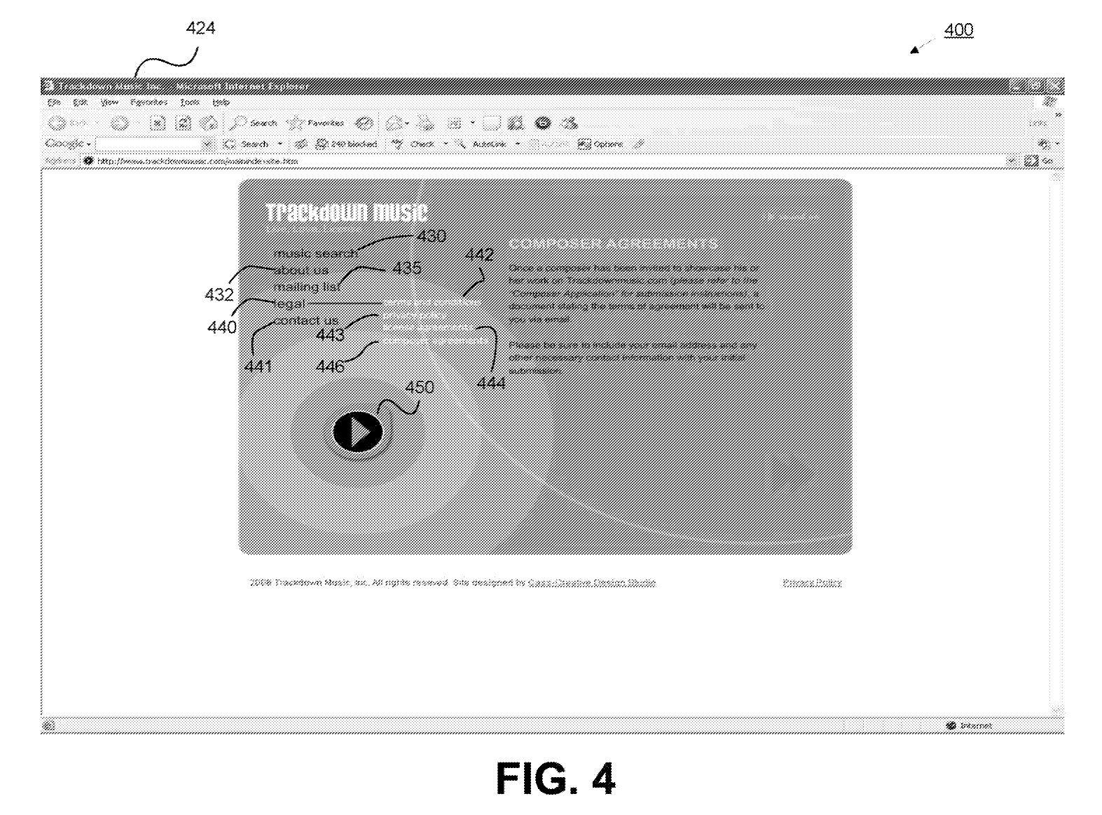

The browser 224 application allows an operator of the client machine 220 to view and interact with web pages that are served by the server 230 over the network connection 240. The browser 224 application may be implemented using any conventional browser technology, and as used herein, the term “browser” generically refers to user interfaces that let a user browse or navigate through content. As used herein, the term “web browser” refers to an application program that provides a way to look at and interact with information on the World Wide Web. A Web browser is a client program that typically uses the Hypertext Transfer Protocol (HTTP) to make requests for information to Web servers throughout the Internet on behalf of the browser user. Examples of Web browsers include Mosaic®, Netscape Navigator®, and Microsoft Internet Explorer®. In the example discussed in below with respect to FIGS. 4-9, the browser is Microsoft Internet Explorer®.

The client identifier 222 is an identifier that uniquely identifies the client 220 at the server 230. For example, in one exemplary implementation, the client identifier can be a code, number or other identifier associated with that particular client of the server 230 (e.g., each particular client has its own unique client identifier 222). At the server 230, the client identifier 222 can be associated with many different types of information maintained at the server 230.

The client 220 also includes a system memory for media storage 226. The media storage 226 component of the system memory can store different types of media such as video files which comply with any video file formats, audio files which comply with audio file formats, or any other known media files such as images, pictures or other media which comply with other formats. In one implementation, the media storage 226 can be implemented as part of a system memory which includes computer storage media in the form of volatile and/or nonvolatile memory such as read only memory (ROM) and random access memory (RAM). The system memory (not shown) can generally provide storage of computer readable instructions, data structures, program modules and other data for the computer. RAM typically contains data and/or program modules that are immediately accessible to and/or presently being operated on by processing unit. The media storage 226 can also be implemented in other removable/non-removable, volatile/nonvolatile computer storage media. Removable/non-removable, volatile/nonvolatile computer storage media that can be used in the exemplary operating environment include, but are not limited to, magnetic tape cassettes, flash memory cards, digital versatile disks, digital video tape, solid state RAM, solid state ROM and the like.

The server 230 includes a number of modules comprising, in this example, a web page server 232, a customer database 234, an audio player application 236, a video player application 238 and a media storage module 237.

The web page server 232 can serve web pages (and other information) over the network 240 which can then ultimately be displayed on the browser 224 of client 220. Some exemplary web pages will be described below with reference to FIGS. 4-10.

The customer database 234 can store information associated with different customers of the server 230, such as a client identifier, and numerous different lists of information in which the customer associated with a particular client identifier. It can also store, for example, contact information and other information associated with that particular customer, client or prospective licensee. The information associated with a particular customer, client or prospective licensee can include, for example, an active play list or favorites play list (created and named by the operator). The operator can use the favorites play list, for example, for use on future projects or sharing with others who might be interested in audio tracks on the play list. These play lists can then be copied and emailed to others who might be interested in particular licensable audio tracks on the play lists. In one implementation, the saved play lists and personal information entered by an operator is accessible only to them via their private login. Other information associated with a particular customer, client or prospective licensee, which can be maintained at the server 230 can include, for example, the operator's notes about particular licensable audio tracks. These examples of information that can be maintained at the server 230 are merely exemplary in nature and not intended to be comprehensive.

The media player application 235 comprises an audio player application 236 and a video player application 238. The audio player application 236 and the video player application 238 can communicate with each other over an interface. Although the audio player application 236 and the video player application 238 are shown as separate modules, as indicated by the dashed-line box surrounding the audio player application 236 and the video player application 238, the audio player application 236 and the video player application 238 can be implemented as part of a single module.

Moreover, while FIG. 2 indicates that depicts that the audio player application 236 and the video player application 238 are implemented at the server 230, in other embodiments, the audio player application 236 and the video player application 238 (depicted relative to the client 220) may be downloaded to the client 220, and then stored and/or executed at the client 220 computer or at another remote memory storage device (as opposed to “at the server 230”). Other program modules, such as, the media storage stored at server 230, can also be executed at either the client 220 of the server 230, depending upon the particular implementation.

As indicated in FIG. 2, the audio player application 236 and the video player application 238 can include a synchronization engine(s) which can allow a particular licensable video and/or audio file to be auditioned against (or with) a particular audio or video file, respectively. In one exemplary implementation, an audio/video file can be uploaded from the client 220 to the server 230, and then auditioned against licensable video/audio files stored in the media storage 237 of the server 230. This allows a client to review several different pieces of copyrighted, licensable video/audio content (stored at the server 230) to be reviewed before making a final selection as to which one to license/purchase (if any).

The synchronization engines in the audio player application 236 and the video player application 238 allow the client to synchronize a media file (e.g., a video file or an audio file) against a particular copyrighted (or copyrightable), licensable media file (e.g., a particular copyrighted, licensable audio file or a particular copyrighted, licensable video file) provided from the media storage 237. The synchronization engines allow the start of an audio file to be synchronized to a timestamp on a video file (or vice versa) thereby reducing a number of repetitive trial and error iterations which are required to synchronize the files at precisely the right timing (e.g., reduce the number of times an audio file must be repeatedly started and stopped at different points with respect to the start of a video file (or vice-versa)). Utilizing a timestamp allows the operator of the client 220 to see exactly where the music and video are meant to be “married” for maximum effect. Utilizing a timestamp also allows the operator of the client 220 to better understand how and where an audio or video needs to be cut in order to achieve maximum impact. Prior techniques did not use exact synch points thereby leaving room for error and, often times, missed the opportunity for heightened effect. Moreover, by storing the synchronization information or relationship between the particular copyrighted, licensable audio file and a particular video file saves the operator a significant amount of time when the operator wants to show the combination to another person who is involved in the decision to license or purchase the licensable audio file.

As such, the audio player application 236 includes a synchronization engine for synchronizing audio files executing on the audio player application 238 when they are played back with, for example, a particular licensable video file loaded from the client 220. For instance, in one exemplary implementation, the synchronization engine can start the audio file at a first time, and start the video file at a second time. In many cases, the first time is offset from the second time by a predetermined amount (determined by the operator of the client 220) which comprises a difference between the first start time and the second start time. For example, in one implementation, the first start time comprises a first time code, and the second start time comprises a second time code or an initial time (0). Alternatively, the first start time comprises a first time code or an initial time (0), and the second start time comprises a second time code. Similarly, the video player application 238 can also include a similar synchronization engine for synchronizing video files executing on the video player application 238 when they are played back with, for example, a particular licensable audio file loaded from the client 220. As such, the synchronization engines can allow audio files to be synchronized with a video file executing on the video player application 238, or vice-versa.

The media storage module 237 is similar to the media storage module 226 in terms of storage functionality in that the media storage module 237 can store any type of media or content including, for example, video files, audio files, etc. However, in contrast to media storage module 226, at least some of the audio files and/or video files stored in the media storage 237 are “licensable” audio or video files which the client 220 can review and potentially license if the client is interested in licensing any of those particular licensable video files or audio files. For example, in one implementation, the media storage module 237 can store an online library of pre-cleared audio content or video content that can be searched, browsed, previewed, licensed/purchased and downloaded immediately for virtually any type of audio-visual work or other commercial use. As used herein, the term “pre-cleared” refers to copyrighted (or copyrightable) media content which the owner is either willing to license or which the owner has authorized another (a second party representative or agent) to license on their behalf.

For example, in one exemplary implementation, the video files and/or audio files may be copyrighted recordings of a video artist or a music artist (such as a band or composer) which are being offered to potential clients for licensing/purchasing opportunities. For instance, representatives of television, commercial, and film producers, seeking licensable audio content for use in conjunction with video content, can visit a web page on the server 230 to search for audio content stored in the media storage 237. This licensable audio content can then be used in conjunction with, for example, their audio-visual work (e.g., television program, commercial or film or in the context of forms of advertising, such as, radio advertising, Internet advertising, etc.) In this context, potential clients (e.g., licensees or purchasers of the copyrighted work) would include anyone in search of audio content for use in conjunction with their video content, and vice versa. For instance, if a television, commercial or film producer is searching for (and finds) particular licensable audio content to play in conjunction with their video work, the producer can then find licensable audio content for which they can obtain a “master use” license and/or a “synchronization or sync” license. Similarly, where a producer of audio content seeks a particular video file for use in conjunction with their audio content, the producer could then visit the web page on the server 230 and review copyrighted, licensable video files which are stored within the media storage 237.

With respect to the operation of the client 220 and server 230 of FIG. 2, an exemplary method will now be described to illustrate how these techniques and technologies can be applied in the context of one exemplary method.

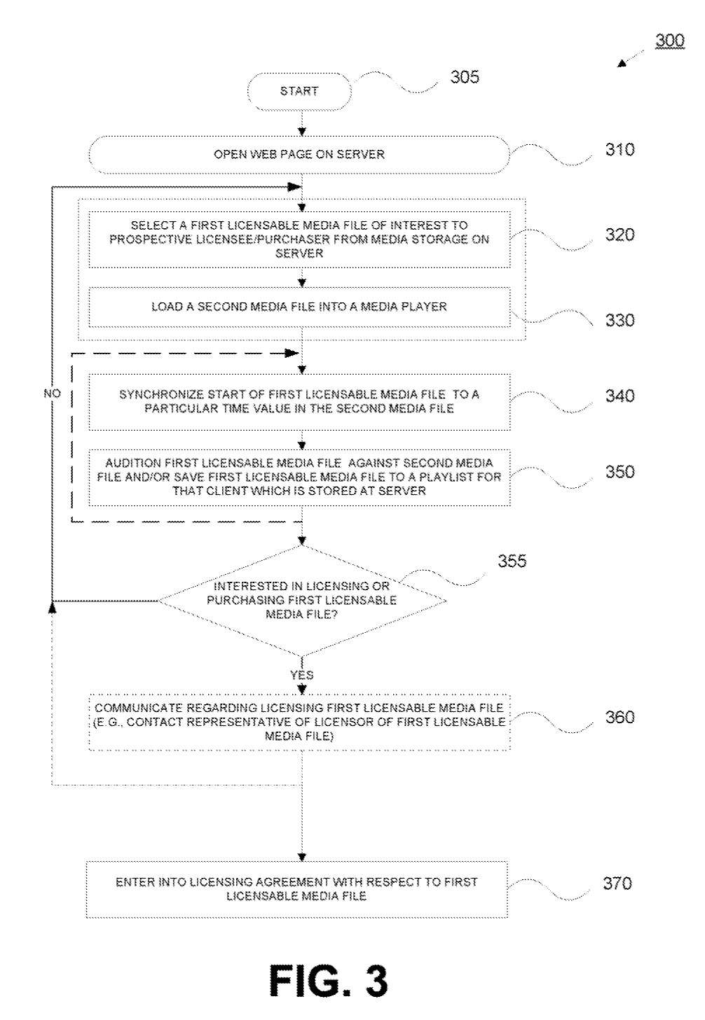

FIG. 3 is a flowchart showing exemplary techniques 300 for synchronizing and/or auditioning a first licensable media file against a second media file to potentially license/sell the first licensable media file to a prospective licensee or purchaser. Although FIG. 3 shows a generalized, non-limiting example of how the system shown in FIG. 2 could be implemented, it will be appreciated that there are numerous different implementations or applications for the techniques 300 shown in FIG. 3. For instance, in one exemplary implementation, techniques 300 of FIG. 3 can be used to facilitate licensing/purchasing of a copyrighted, licensable audio file to a prospective licensee/purchaser, or to facilitate licensing/purchasing of a copyrighted, licensable video file to a prospective licensee/purchaser.

The process 300 starts at step 305. It will be appreciated by those skilled in the art that a number of web pages can be served between step 305 and step 310, and that an operator of client 220 can encounter numerous different web pages before reaching the web page opened by the client 220 at step 310. Some exemplary web pages which might be served are described below with reference to FIGS. 4-9, however, it will be appreciated that these web pages are merely exemplary in nature and that other web pages including other functionality can be incorporated. For example, the operator of the client 220 may first encounter a login page where the operator enters a client identifier and password associated with the operator or the client 220 which thereby allows the client 220 to enter a restricted area of the website which may contain projects the operator has worked on in the past which can be stored at the server 230.

At step 310, an operator of the client 220 opens a web page on server 230 to view information that can be stored at the media storage 237 of server 230. The operator can be, for example, a prospective licensee/purchaser, an agent or other representative of the prospective licensee/purchaser, or some other person which is currently affiliated with or which may eventually become affiliated with the prospective licensee/purchaser. The web page includes, among other things a list or library of licensable media files (e.g., licensable audio files or licensable video files) stored at 237. The list or library of licensable media files can be owned by any number of copyright holders of licensable media files.

At step 320, the operator of the client 220 reviews licensable media files stored at the media storage 237 on server 230 (e.g., a library of licensable media files stored in the media storage 237), and selects a first licensable media file (which might be of interest to the prospective licensee/purchaser) from the media storage 237. For instance, in one exemplary implementation, the operator of the client 220 selects at least one licensable audio file (of interest to a prospective licensee/purchaser) from the media storage 237 on server 230. In another exemplary implementation, the operator of the client 220 selects at least one licensable video file (of interest to a prospective licensee/purchaser) from the media storage 237 on server 230.

At step 330, the operator of the client 220 loads a second media file stored locally at the client 220 into the media player application 235 which can be located at either the client 220 or the server 230. The second media file can be executed (e.g., played by) the media player application 235 whenever the operator decides to play the second media file.

For example, in one implementation of step 330, the operator of the client 220 can transmit the second media file, over the network connection 240, to the server 230 (e.g., the operator of the client 220 can upload the second media file stored locally at the client 220 into the media player application 235 at the server 230). The second media file can then be played at the server 230 against (e.g., in comparison to and/or compared against) a first licensable media file selected by the operator from the media storage 237 at server 230. In one exemplary implementation, the selected licensable media file can be a licensable audio file. The selected licensable media file can be a licensable video file or a licensable audio file. For instance, in one implementation of step 330, the operator of the client 220 uploads an audio file from the media storage 226 on client 220 to the server 230. The audio file can then be played against a licensable video file selected by the operator from the media storage at server 230. In another implementation of step 330, the operator of the client 220 uploads a video file from the media storage 226 on client 220 to the server 230. The video file can then be executed or played against a licensable audio file selected by the operator from the media storage 237 at server 230.

In yet another exemplary implementation of step 330, in which the client 220 has the media player application running locally (e.g., where the media player application has been previously downloaded to the client 220), the operator of the client 220 loads a second media file from the media storage 226 on client 220 into a media player application running on the client 220 (e.g., the operator of the client 220 can locally load the second media file stored into the media player application 235 at the client 230, or the operator of the client 220 can upload the second media file stored locally at the client 220 into the media player application 235 at the server 230). The operator of the client 220 can then use the second media file in conjunction with the first licensable media file downloaded from the server to the client 220 over the network connection 240. As above, the selected first licensable media file can be a licensable video file or a licensable audio file. For example, in still another exemplary implementation of step 330, in which the client 220 has the media player application 235 running locally (e.g., where the media player application 235 has been previously downloaded to the client 220), the operator of the client 220 can load an audio file from the media storage 226 on client 220 into a media player application running 235 on the client 220. The operator of the client 220 can then use (e.g., execute or play) the audio file in conjunction with the licensable video file downloaded from the server 230 to the client 220 over the network connection 240. In a further exemplary implementation of step 330, in which the client 220 has the media player application 235 running locally (e.g., where the media player application 235 has been previously downloaded to the client 220), the operator of the client 220 can load a video file from the media storage 226 on client 220 into a media player application running 235 on the client 220. The operator of the client 220 can then use (e.g., execute or play) the video file in conjunction with the licensable audio file downloaded from the server 230 to the client 220 over the network connection 240.

In the following description, the order of the steps 340 and 350, is not limiting, and these steps could occur in the opposite order of that described below (e.g., step 340 before step 350).

At step 340, the operator of the client 220 synchronizes the start of the first licensable media file to a particular location, for example, a timestamp, associated with the second media file. Auditioning the first licensable media file against the second media file involves the process of playing both the first licensable media file and the second media file simultaneously. In many cases, the start of either the first licensable media file or second media file can be offset relative to the start of the second media file or first licensable media file, respectively. In other words, the start time of the respective files may be offset relative to one another, for example, using a time code or time stamp.

For instance, in one exemplary implementation, the operator of the client 220 synchronizes the start of the particular licensable audio file selected from the server 230 to a timestamp on the video file.

Alternatively, at step 340 the start of the video file from the client 220 to the server 230 can be synchronized to a timestamp of the particular licensable audio file that was selected from the media storage 237 of server 230. Alternatively, the operator of the client 220 can synchronize the start of the audio file from media storage 226 to a timestamp on the licensable video file selected from the media storage 237 of server 230 at step 320.

In one implementation, the functionality required for synchronization of the audio file to the video file (and vice versa) can be provided at server 230. In other words, the video player application 238 and the audio player application 236 both include a synchronization engine which allows the start of the audio file to be synchronized to a timestamp on the video file (or in an alternative implementation allows the start of the video file to be synchronized to a timestamp on the audio file).

In another implementation, where the media player application 235 has been downloaded to the client 220, the functionality required for synchronization of the audio file to the video file (and vice versa) can be provided at the client 220. In other words, the video player application 238 and the audio player application 236 both include a synchronization engine which allows the start of the audio file to be synchronized to a timestamp on the video file (or in an alternative implementation allows the start of the video file to be synchronized to a timestamp on the audio file).

Once the operator 320 of the client has synchronized the start of the first licensable media file to a particular location/time in the second media file, at step 350, the operator can instruct the media player application to execute or play the first licensable media file against the second media file to audition the first licensable media file against the second media file.

An optional dotted-line loop is shown after step 350. This loop returns to step 340 to indicate that the process at steps 340 and 350 can be repetitive. In other words, if the operator of the client 220 deems it necessary, the operator of the client 220 can repeatedly synchronize the start of the first licensable media file to different particular locations/time offsets into the second media file until the operator of the client 220 has determined a particular location/time in the second media file at which they desire to begin play back of the start of the first licensable media file. In addition, if the operator of the client 220 finds a selected first licensable media file that is “of interest,” then the operator of the client 220 can save the first licensable media file, for example, to a play list or favorites list. The play list or favorites list can be useful, for instance, when the operator of the client 220 wants to save a particular licensable media file for consideration at a later time while operator of the client 220 reviews other licensable media files stored in the media storage 237. In one exemplary implementation, an ad agency creative can begin the process of creating a commercial with a concept. In order to fully present that idea to his/her client, he/she may need what's known as temporary or “temp” music to sell the idea. Having one reliable, up-to-date interactive resource where he/she can find a wide variety of musical genres and can store all of his/her selections in one readily available place—accessible from any computer anywhere—saves numerous hours of time searching the vast music options, dubbing selected cuts to CD (or the like) then trying to find that compilation later in the process. And if the client likes the temp track on the spot, a representative from the agency can reserve the track for a limited time. The same concept applies when a commercial is actually being edited and music is needed to drive the cut. The editor or an agency creative can return to his collected “favorites” lists—all housed in one location—and audition those tracks against the working picture.

In one exemplary implementation of step 350, the operator of the client 220 auditions the licensable audio file selected from the media storage 237 of server 230 against the video file from the media storage 226 of client 220. In another exemplary implementation, the operator of the client 220 auditions the audio file against the licensable video file selected from the media storage 237 of server 230. This may be a repetitive or iterative process in which the operator of the client 220 reviews the particular licensable media file (e.g., audio file or video file) that was selected at step 320 against the second media file to determine the best synchronization for the particular licensable media file and second media file so that the file can be auditioned against or with respect to each other.

The server 230 is configured to receive a message or other indication from the client 220 to store the synchronized licensable media (e.g., audio) file and the second media (e.g., video) file when the operator of the client 220 determines that they want to save a particular synchronization of the licensable media (e.g., audio) file and the second media (e.g., video) file. This allows the operator to save a project at the server, and then automatically retrieve the synchronized licensable media (e.g., audio) file and second media (e.g., video) file when the operator (or other person) revisits the server 230 at a later time to determine if they are interested in licensing or purchasing the licensable media (e.g., audio) file. This can save time everyone involved in making a decision about licensing or purchasing the licensable media (e.g., audio) file

Once the operator of the client 220 has auditioned the first licensable media file against the second media file, at step 355 the operator can determine whether or not they are interested in licensing/purchasing the first licensable media file. For instance, in one exemplary implementation, the operator of the client 220 determines if the prospective licensee/purchaser would potentially be interested in licensing the particular licensable audio file selected at step 320. In another exemplary implementation, once the operator of the client 220 has auditioned the audio file against the video file and settled on an appropriate synchronization of the timestamp on the video file to the audio file or vice versa, the process proceeds to step 355 where the operator of the client 220 determines whether the prospective licensee/purchaser would be interested in licensing the particular licensable media file selected at step 320.

If the operator of the client 220 is not interested in licensing the first licensable media file, then the process 300 loops back to step 320 where the operator selects another licensable media file of interest to the prospective licensee from the media storage 337 on server 230. The process shown in steps 320 through 350 can then repeat until the operator of the client 220 determines or selects a particular first licensable media file, which the prospective licensee/purchaser would potentially be interested in licensing/purchasing. For instance, in one exemplary implementation, if the operator is not interested in licensing a particular licensable audio file then the process 300 loops back to step 320 where the operator of the client 220 selects another licensable audio file of interest to the prospective licensee/purchaser from the media storage 337 on server 230. At this point, steps 320 through 350 can repeat. In another exemplary implementation, if the operator of the client 220 determines that the prospective licensee/purchaser would not be interested in licensing the particular licensable video file selected at step 320, then the process reverts to step 320 where the operator of the client 220 can select another licensable video file from the media storage 237 at server 230. Steps 330 through 350 will then repeat until step 355 is reached where the operator of the client 220 can then again determine whether the prospective licensee/purchaser is interested in licensing the licensable video file selected at step 320. If the operator of the client 220 determines that the prospective licensee is interested in licensing the particular licensable video file selected at step 320, then the process 300 proceeds to step 360.

If the operator of the client 220 is interested in licensing/purchasing the first licensable media file, then the process 300 can proceed to step 360, where a representative of the prospective licensee/purchaser communicates with a representative of the licensor.

Step 360 is presented in a dotted line box to indicate that step 360 is optional (i.e., because it is marked with a dotted or dashed lined box). To the extent step 360 is implemented, then step 360 can include any number of communications between the parties (e.g., the operator/prospective licensee and the agent/representative of the licensor). In other words, depending upon the particular implementation, steps which occur at step 360 (not shown) will change or vary according to the context of a particular transaction regarding the particular licensable media file which has been selected. As such, step 360 can include many additional or alternative steps (not shown) that may be performed by the operator/prospective licensee and/or an administrator/operator/supervisor of the server 230. For instance, a representative of the licensor for the particular licensable media file selected at step 320 (and/or the operator of the client 220 and/or the prospective licensee/purchaser of the file selected at 320), may conduct transactions according to any one of a few exemplary scenarios described below.

In one exemplary implementation of step 360, if the operator of the client 220 determines that the prospective licensee/purchaser would be interested in licensing/purchasing a particular licensable media file (e.g., that was most recently selected at step 320), then the operator of the client 220 can submit a request to the server 230 to be contacted by a representative of the licensor about potentially licensing/purchasing the particular licensable media file selected most recently at step 320. The server 230 can then provide a notification to the representative of the licensor that the prospective licensee/purchaser is interested in licensing/purchasing the particular licensable media file. This notification can comprise information such as contact information for the prospective licensee, etc. Thereafter, the representative of the licensor may contact the prospective licensee/purchaser about licensing/purchasing the particular licensable media file that was selected.

In another exemplary implementation, when the operator of the client 220 determines that the prospective licensee/purchaser would be interested in licensing/purchasing a particular licensable media file (e.g., that was most recently selected at step 320), then at step 360, the operator of the client 220 can contact (or submit a request) to the server 230 for license materials associated with the first licensable media file. The server 230 can then provide these license materials to the client 220 over the network connection 240, or a representative of the licensor may contact the prospective licensee/purchaser regarding obtaining a license for or purchasing the particular licensable media file that was most recently selected at step 320. The client 220 can submit license materials to the server 230 regarding the prospective license/purchase.

In one particular implementation, an online form can be sent from the server 230 and displayed on the browser 224 of the client 220. An operator of the client 220 can print the form or directly enter information into the form that is useful for licensing/purchasing the particular licensable media file that is selected. A representative of the licensor can then eventually receive the completed license materials from the prospective licensee by either receiving a soft copy of the completed licensing materials over the network connection 240 or receiving a completed hard copy of the licensing materials by other means.

Depending on the interest of the operator of the client 220 in other licensable media files stored in the media storage 237, the process 300 can either loop back to step 320 or can end at step 370 when the licensor and licensee enter into an agreement to license or purchase the first licensable media file.

To present an example of how the techniques for providing prospective licensees/purchaser with access to licensed media content, a description will now be provided in which FIGS. 4-9 describe a number of different screen shots which show various web pages which can be served by the server 230 over the network 240 to the client 220 and displayed on the browser 224. The operator of the client 220 can then interact with web pages displayed on the browser 224.

FIG. 4 shows a screenshot 400 of a browser 224 displaying a particular web page served by the web page server 232 of server 230 to the client 220. This web page can be displayed on the browser 224 executing at client 220 and provides the operator of the client 220 with a menu to links comprising: a music search link 430, an about us link 432, a mailing list link 435, a legal link 440, a contact us link 441 and a button 450.

The legal page link 440 comprises items, such as, a terms and conditions link 442, a privacy policy link 443, a license agreements link 444 and a composer agreements link 446. In the particular example shown in FIG. 4, the operator of the client 220 has selected the composer agreements link 446 which allows a composer visiting the web site to obtain (e.g., via email) or download a composer application and/or other documents stating the terms of the composer's agreement with a representative of the composer/licensor. The composer application can also allow the composer to submit their contact information to a representative via the server 230. If the representative is interested in entering into a contract with the composer to represent the composer (e.g., regarding licensing/purchasing of the composer's copyrighted licensable audio works), then the representative can contact the composer.

The web page also includes a license agreements link 444, which includes sample license agreements which can be entered into between the particular composer/licensor and the representative. At least some of these sample license agreements relate to the terms between of a contract between the composer/licensor and the representative of the web site for displaying or showcasing the composer's audio works on the web site, and licensing the composer's works to a third party licensee (e.g., if the audio works of that composer/licensor are licensed/purchased by a particular licensee/purchaser).

The button 450 allows the person viewing the Web Page 400 to navigate back to the first web page (or “home” page) of the web site.

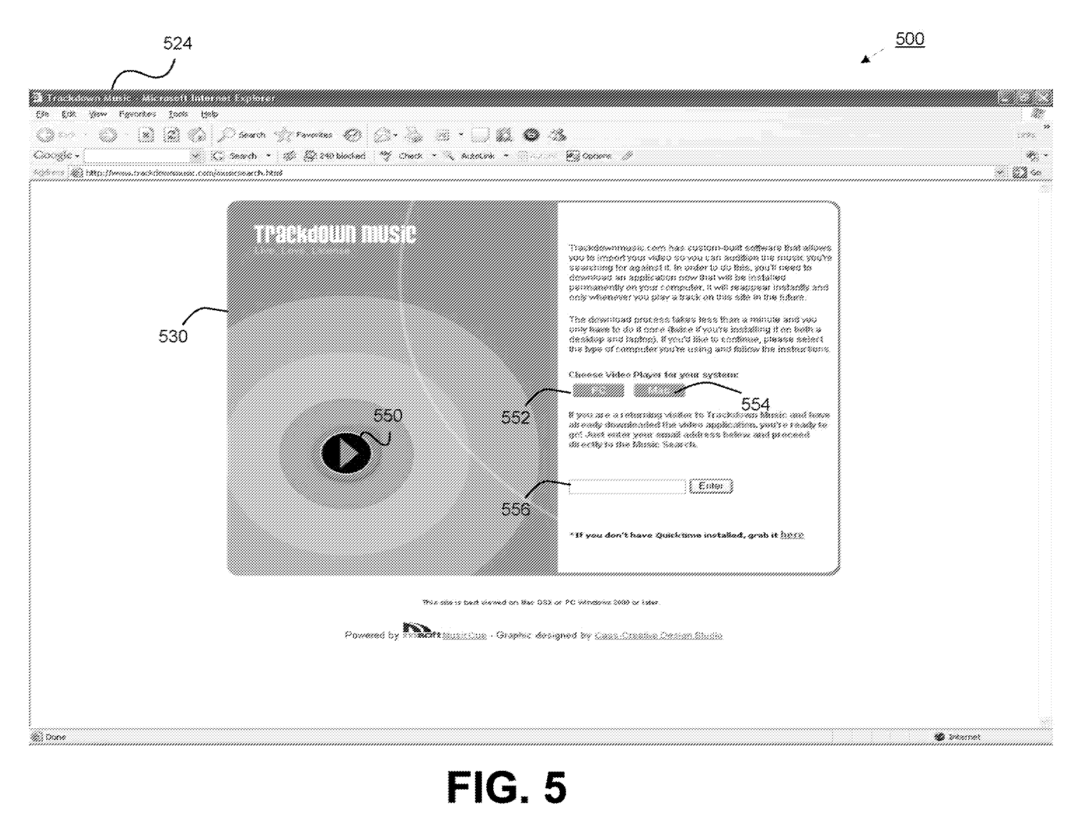

FIG. 5 shows a screenshot 500 of a browser 524 displaying another particular web page served by the web page server 232 of server 230 to the client 220. This web page is displayed on the browser 224 executing at client 220 and provides the operator of the client 220 with information which allows client 220 to load (e.g., download) a media player application 235 to the client 220 or to load the media player application 235 at the server 230.

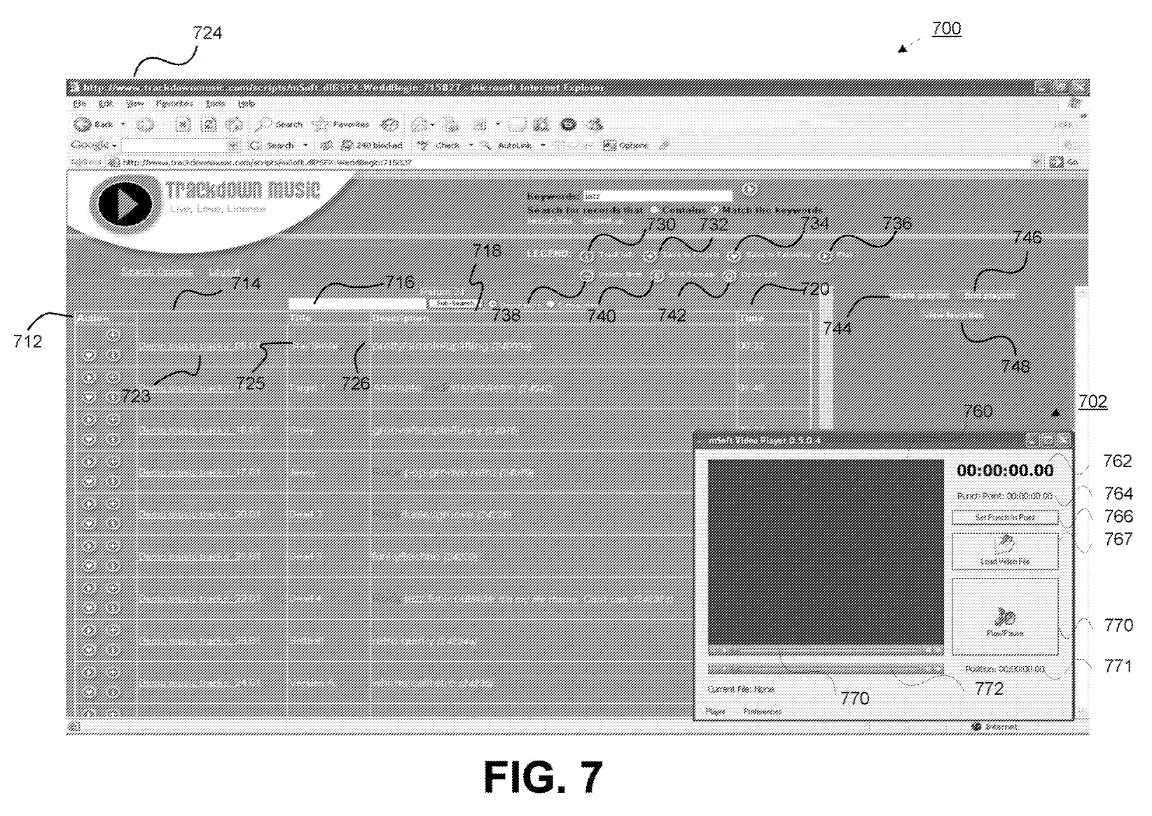

In this particular example, the operator of the client 220 can select a particular version of the media player application 235. For example, the operator of the client 220 can select either a PC version of the media player application 235 by clicking on button 552 or a MAC operating system version of the media player application 235 by clicking on button 554. The media player application 235 is described in detail above with reference to FIGS. 2 and 3 and below with reference to FIG. 7, and will not be described here again in detail.

In addition, if an operator of a client 220 have already downloaded the media player application 235 to their computer, then the operator can enter in a client identifier, such as an e-mail address, into text box 556, and then proceed directly to another web page which allows the operator of the client 220 load the media player application and to enter a music search page.

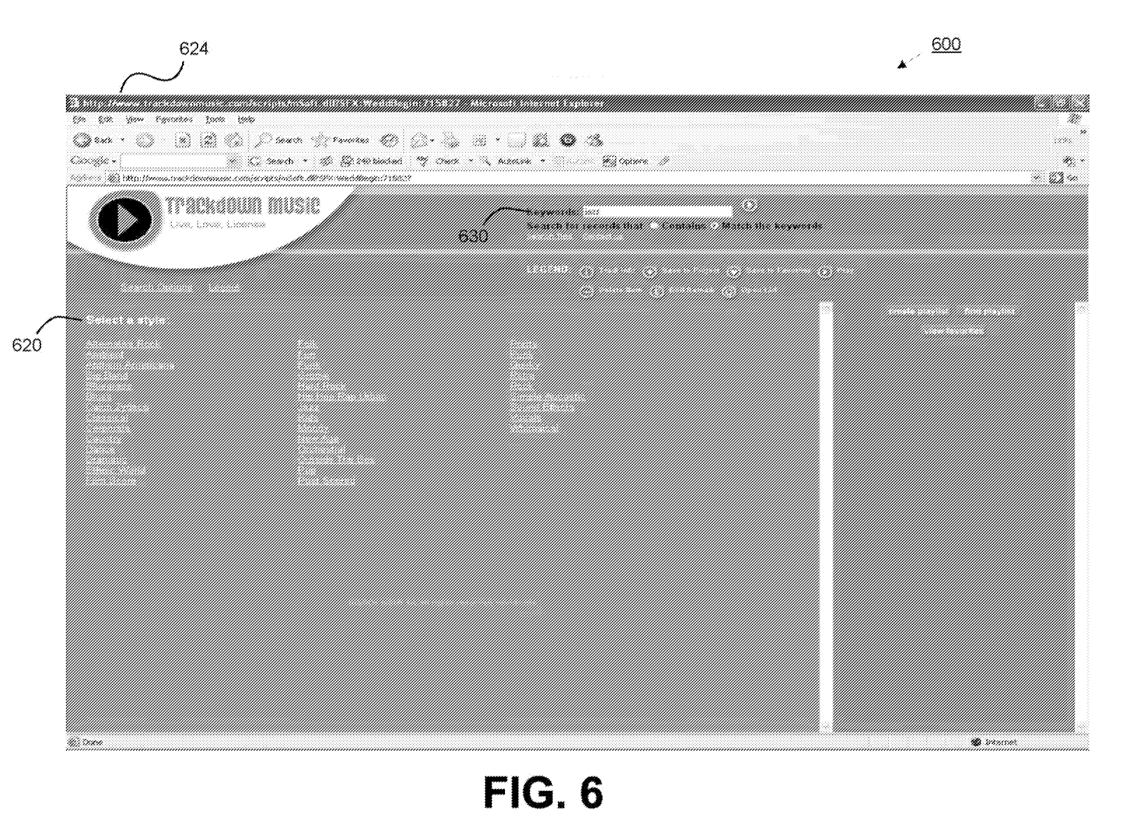

FIG. 6 shows a screenshot 600 of a web page of a browser 524 displaying another particular web page served by the web page server 232 of server 230 to the client 220. This web page can be displayed on the browser 224 executing at client 220 and provides the operator of the client 220 with functionality for searching for licensable audio files stored in the media storage 237 at server 230.

To search for particular licensable audio files stored at the server 230, the operator of the client 220 can select a link associated with a particular style of music. In this particular example, different styles of music are shown under a “select a style” tab 620. The operator can perform a search, by selecting a link under the “select a style” tab 620 and then going through a listing of different entries associated with a particular style of music.

In addition, search engine functionality is provided which allows an operator of the client 220 to search for particular licensable audio files by entering keywords into a textbox, and then search for particular matches to those keyword(s) or to audio files which contain the particular keyword(s).

Once the search results are provided (not shown in FIG. 6), the operator of the client 220 can review different licensable audio files which are returned. At this point, the operator of the client 220 has a number of options, some of which will be discussed below with respect to FIG. 7 and buttons 730-748.

FIG. 7 shows a screenshot 700 of a browser 724 displaying a particular web page served by the web page server 232 of server 230 to operator of the client 220. This web page is displayed on the browser 224 executing at client 220 and provides the operator of the client 220 with information comprising search results associated with a particular search run by the user.

In this particular example, when the operator of client 220 has run a search, the web page displays the results of the search in a table format which lists the licensable audio files which match the particular search criteria. In an exemplary implementation, the search results (i.e., the licensable audio files which match the search criteria) are displayed in a 5-column table which comprises an Action Column 712, a Track Column 714, a Title Column 716, a Description Column 718 and a Time or Duration Column 720.

The Action Column 712 includes a number of different buttons 730, 732, 734, 736 associated with a particular licensable audio file. The various functions associated with the buttons 730, 732, 734, 736 will be described below. It will be appreciated that the buttons 730, 732, 734, 736 are just some example of buttons that can be included in the Action Column 712, and that any other buttons could also be provided in the Action Column 712.

The Track Column 714 provides a link which allows the operator of the client 220 to load and play a particular licensable audio file into the media player application 702.

The Title Column 716 includes the titles associated with a particular licensable audio file, and the Description Column 718 includes keywords and operator comments/notes that are associated with a particular licensable audio file.

The Time Column 720 includes the duration of the particular licensable audio file (e.g., length of time the particular licensable audio file executes or runs for).

For example, the first row of the table includes a licensable audio file titled “Star Smile” 725 which has a duration of 32 seconds, and a description 726 associated with it which includes the keywords pretty/simple/uplifting and operator notes regarding the licensable audio file. The particular actions associated with a licensable audio file titled “Star Smile” 725 include an option for saving it to a favorites list, saving it to a project's list or obtaining track information associated with the licensable audio file titled “Star Smile.” In addition, by clicking on Link 723, the operator of the client 220 can load the “Star Smile” audio file 725 into the media player application 702. At this point, it is assumed that the operator of the client 220 is possibly interested in either licensing and/or purchasing the “Star Smile” audio file 725. When the operator clicks on Link 723, the “Star Smile” audio file loads into the media player application 702 and the operator can load a particular video file into the media player application 702 which they would like to synchronize and audition against the “Star Smile” audio file 725.

The web page also includes a legend field which describes the functions of a number of buttons or icons 730-748 that can be used in the Action Column 712.

Button 730 allows the operator to display particular “track” information associated with a particular licensable audio file. This information can include, for example, when and where a selected licensable audio file has been licensed before, the name of the composer/licensor, information about the composer/licensor (composer names and information), the operators notes regarding the particular licensable audio file, the genre style(s) in which the music falls, etc.

Button 732 allows the operator to save the particular licensable audio file to a particular project list. The project lists can be maintained in the customer database 234 associated with a particular client identifier 222.

Button 734 allows the operator to save that particular licensable audio file to a favorites list. Button 742 also allows the operator of the client 220 to create a particular play list of list of licensable audio files which the operator has previously selected and added to the list. The favorites lists can also be maintained in the customer database 234 associated with a particular client identifier 222.

Button 736 allows the operator of the client 220 to play a particular licensable audio file. Button 738 allows the operator to delete the particular entry from a particular project list, favorites list or play list is maintained in the customer database 234 at server 230. Button 740 allows the operator to add or edit his or her previously written personal remarks about a particular licensable audio file the operator has selected and possibly added to a play list or a project list. Button 742 allows the operator to open an existing play list. Button 744 allows the operator of client 220 to create a play list which comprises a number of licensable audio files the particular operator associated with a particular client identifier 222 has created (e.g., added to the play list). Button 746 allows the operator of the client 220 to find a particular previously created play list associated with the client Identifier 222 of that operator.

Button 748 allows the operator of the client 220 to view a favorites list of licensable audio files which the user has created, for example, by utilizing buttons 734. This way if a particular operator or client associated with the client identifier 220 has particular licensable audio files which they would like to review more than one time or come back to at a later time, a listing of these particular licensable audio files can be maintained at the server 230 in the customer database 234.

FIG. 7 also includes a screenshot which shows an example of the graphical user interface (GUI) for the media player application 702. The GUI of the media player application 702 can be used to display and execute a video file loaded or uploaded from the client 220 on screen 760, and to synchronize the video file, and audition it against, a particular licensable audio file from the media storage 237 of server 230. The GUI of the media player application 702 comprises a Control Bar 770 which the operator of the client 220 can use to play, pause, rewind or fast forward the video file, another Control Bar 772 which the operator of the client 220 can use to play, pause, rewind or fast forward a particular licensable audio file.

The operator of the client 220 can load a particular video file by clicking on the Button 767. This will allow the operator to browse through directories on the client 220 which contain different video files the particular operator would like to audition against licensable audio content provided from the media storage 237 of server 230.

Once the operator of client 220 has loaded the particular video file (which they are interested in auditioning against licensable audio content), the operator of the client 220 can select a particular licensable audio file from the media storage 237 of server 230.

The operator of the client 220 can then control playback of the licensable audio file using Control Bar 772. The Control Bar 772 allows the operator of the client 220 to play the licensable audio content, to pause the licensable audio content, and fast forward or rewind the licensable audio content using the different control buttons provided on the Control Bar 772. As such, the Control Bar 772 can be used to control the playback of the licensable audio file independently of the video file that is executing within the media player application 702. Similarly, the operator of the client 220 can also control playback of the video file using Control Bar 770. The Control Bar 770 allows the operator of the client 220 to play, pause, and fast forward or rewind the video file using the different control buttons provided on the Control Bar 770. As such, the Control Bar 770 can be used to control the playback of the video file independently of the licensable audio file that is executing within the media player application 702.

A Clock 762 displays a time code associated with the particular video file loaded from the client 222. The Clock 762 generally will start at time zero at the beginning of the video file and stop at the end of the video file (e.g., the video file will reach a final number at the end of the video file). In this particular implementation, the Clock 762 has the format of hours, minutes, seconds and 1/100ths of a second (00:00:00.00).

The Control Bar 772 which controls playback of the licensable audio file also has a Clock 771 associated therewith. The Clock 771 increments or decrements as the particular licensable audio file is played, fast forwarded or rewound. The Clock 771 generally will start at time zero at the beginning of the particular licensable audio file and stop at the end of the particular licensable audio file (e.g., the particular licensable audio file will reach a final number at the end of the particular licensable audio file). In this particular implementation, the Clock 771 has the format of hours, minutes, seconds, and 1/100ths of a second (00:00:00.00). For example, the Clock 771 generally starts at time zero at the beginning of the licensable audio file before it is played, and increments by 1/100ths of a second as the particular licensable audio file continues to execute or play.

Another Clock 764 is provided to display the timing of a punch point. A “punch point” refers to a time offset into a particular video file (or alternatively a licensable audio file) from the start of the licensable audio media file that is set or defined by the operator of the client 220. The operator of the client 220 sets the punch point by selecting or depressing Button 726; the operator of the client 220 can set the punch point wherever they deem appropriate. A “punch point” is a type of time stamp (or offset from the start of the particular video file) which the operator of the client 220 can use to precisely synchronize the start of the licensable audio file with respect to a particular point in time in the video file (or vice-versa). Alternatively, a punch point can be used to synchronize the start of the video file to a particular offset into the licensable audio file.

For example, after becoming comfortable with the flow of the licensable audio file and the flow of the particular video file which are executing in the media player application 702, the operator the client 220 can experiment with different timing relationships between the start of the licensable audio file and playback of the video file.

For instance, the operator of the client 220 may decide that they would like the video file to start playing at 2 minutes and 12.03 seconds into the video file with respect to the start of the licensable audio file. At that time, the operator of the client 220 can set a punch point by selecting or clicking on Button 766.

To provide another example, if the operator of the client 220 would like the licensable audio file to begin playing at 1 minute, 32.24 seconds into the video file (loaded from the client 220 into the media player application 702), then the operator of the client 220 could set a punch point at 00:01:32.24 into the licensable audio file by depressing (e.g., selecting or clicking) Button 766. This punch point can then be synchronized to the start time of the particular video file. In an alternative implementation, if the operator of the client 220 would like the video file to begin playing at 1 minute, 6.14 seconds into the licensable audio file, then the operator of the client 220 could set a punch point at 00:01:06.14 by depressing Button 726.

To provide yet another example, if the operator of the client 220 would like the audio file to begin at 1 minute, 11.32 seconds from the beginning or start of the video file (loaded from the client 220 into the media player application 702), then the operator can set a punch point or offset at 1 minute, 11.32 seconds into the licensable audio file by depressing (e.g., selecting or clicking) Button 726. This punch point can then be synchronized to the start time of the particular video file.

In addition, by toggling Button 766, the operator of the client 220 can remove a particular punch point (e.g., while the operator of client 220 auditions and attempts to synchronize the licensable audio file at various points within the video file which they are interested in using the licensable audio file with).

For instance, the operator may initially audition the video file against the licensable audio file and decide that the start of the licensable audio file should begin at 2 minutes and 1 second into the particular video file. However, after further reviewing different combinations of the start point of the licensable media file and different punch points or offsets into the video file, the operator of the client 220 may decide that they would like to reset the punch point. If so, then the operator can reset the punch point using the Button 766. This way, the operator of the client 220 can continue to audition the particular video file against the licensable audio file using the Control Bars 770 and 772 to determine an optimal starting point of the licensable audio file with respect to a particular time offset into the video file (or vice-versa). For example, a punch point into the video file can be used to automatically return to the start of the video file every time a licensable audio file begins, or, in another implementation, a punch point into the a licensable audio file can be used to automatically return to the start of a licensable audio file every time a video file begins.

To provide another example, as the operator of the client 220 continues to review the video file, the operator may decide that they would like to reset the punch point so that the start of the licensable audio file begins, for example, at 3 minutes, 13.01 seconds into the licensable audio file. If so, then the operator can reset the punch point using the Button 766.

There are a number of benefits associated with this synchronization mechanism. For example, by setting a particular punch point within the video file, the operator of the client 220 can then synchronize the start of the licensable audio file to this particular punch point. This way, the operator of the client 220 always knows the precise synchronization they desire for that combination of the video file and the particular licensable audio file. Once the operator of the client 220 has decided that they have identified a desired punch point the operator of the client 220 can save the punch point information, and use it later without needing to go through the synchronization and auditioning processes again. This is particularly beneficial if the operator (or someone else working with the operator) wants to go back and audition the particular licensable audio file/video file pair at a later time.

For example, once the operator has had an opportunity to review the “Star Smile” audio file 725, the operator can audition the “Star Smile” audio file 725 against a particular video file they have loaded into the media player application 702. To synchronize the “Star Smile” audio file 725 and the video file, the operator can set a particular timestamp or punch point which defines either an offset into the video file the operator has loaded from media storage 226 (or an offset into the “Star Smile” audio file 725).

Thus, it can be appreciated that the functionality provided by the Web Page 700 in conjunction with the media player application 702 can greatly facilitate the process of auditioning licensable audio files thereby saving prospective licensees/purchasers valuable time in auditioning the particular video file against licensable audio file(s) and obtaining the precise synchronization the operator desires between the video file and licensable audio file.

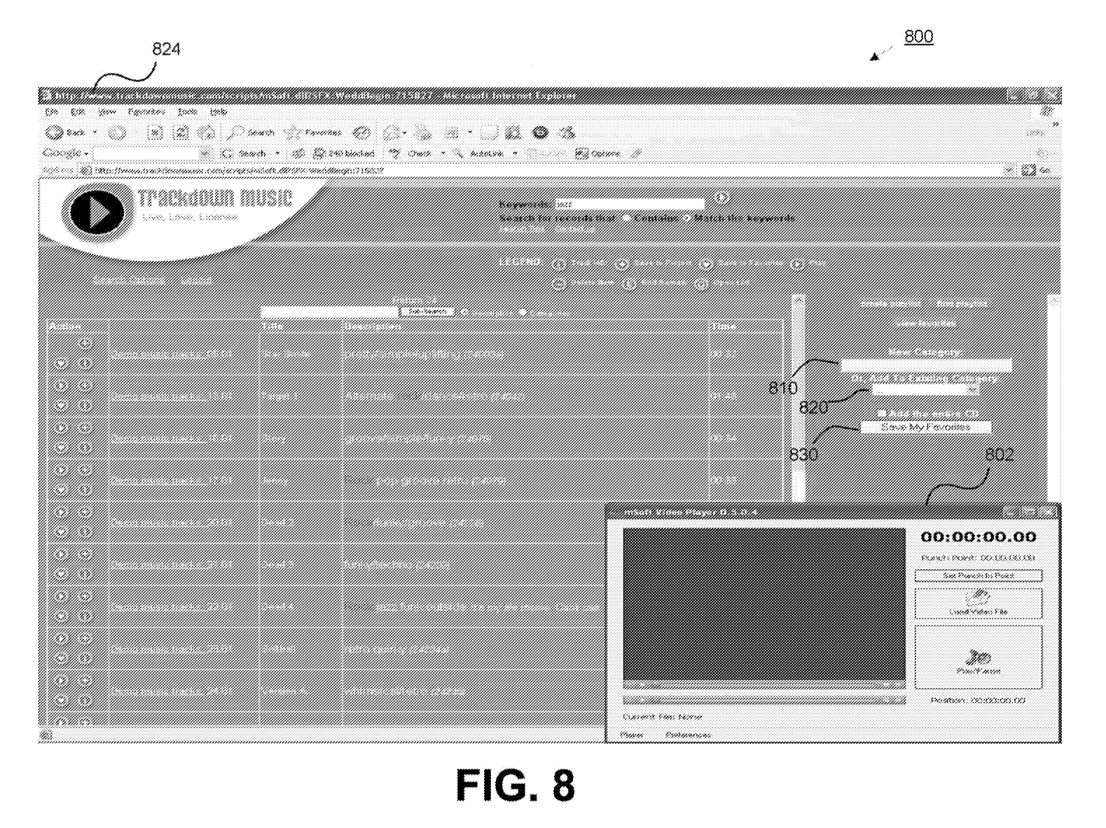

FIG. 8 shows a screenshot 800 of a browser 824 displaying a particular web page served by the web page server 232 of server 230 to the client 220. This web page is displayed on the browser 224 executing at client 220 and provides the operator of the client 220 with information which can allow an operator of client 220 to manage and keep track of particular licensable audio files the operator has an interest in, as well as information associated with those particular licensable audio files.

In FIG. 8, the operator can use Text Box 810 to create a new category for storing a selected licensable audio file. Likewise, Text Box 820 includes a drop down menu, which allows the operator of the client 220 to add the selected licensable audio file to an existing category created by the operator. Again these categories can be maintained in the Customer Database 234 of the server 230, and can allow the operator to maintain a list or lists of licensable audio files the particular operator is potentially interested in licensing/purchasing for use with their video content. In addition, Button 830 allows the operator to save a selected audio file to that operator's favorites list.

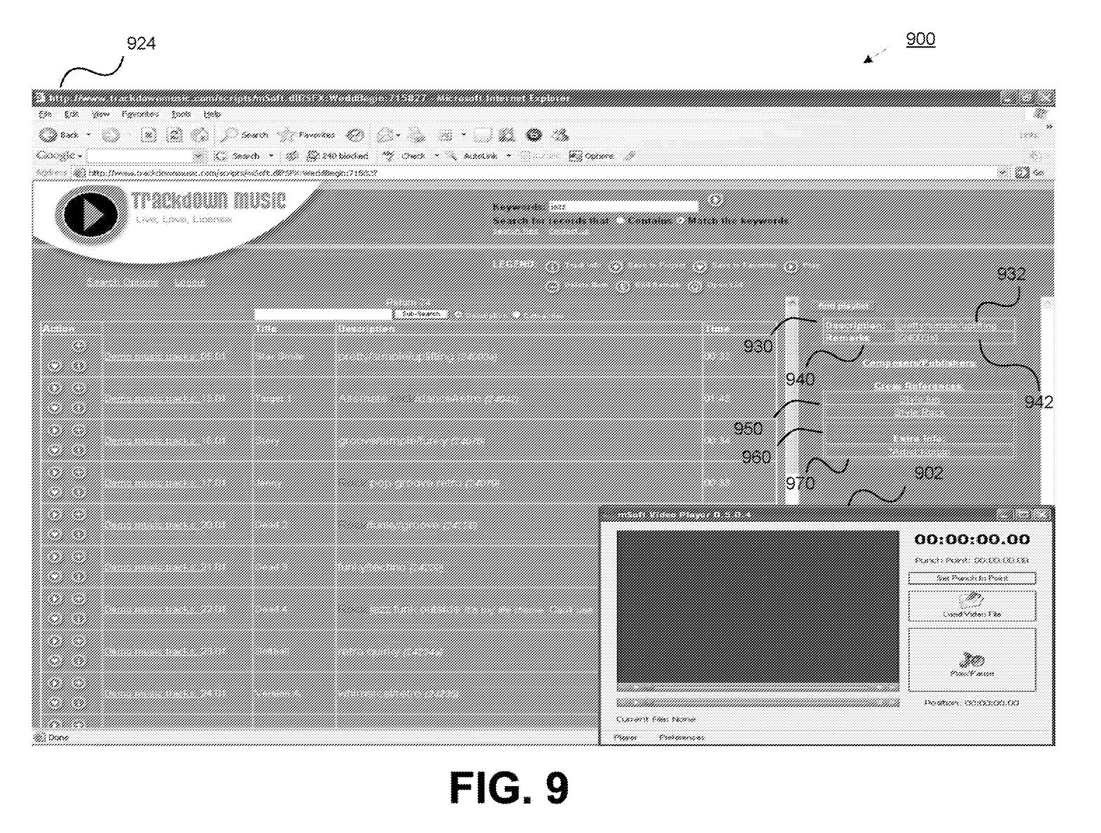

FIG. 9 shows a screenshot 900 of a browser 924 displaying a particular web page served by the web page server 232 of server 230 to the client 220. This web page is displayed on the browser 224 executing at client 220 and provides the operator of the client 220 with additional information which is associated with a particular licensable audio file and that can be maintained in a Customer Database 234. This information can include, for example, description information 930 and the Operator's Remarks 940 associated with the selected licensable audio file (this information can be obtained from the Description Column 718 for the licensable audio file), and cross references to other information such as the style 950 of the licensable audio file and any extra information 960 the operator would like to maintain, such as, information regarding the particular composer or publisher 970 of that selected licensable audio file.

For example, in the example described above where the licensable audio file is titled “Star Smile,” the operator of the client 220 may store certain information associated that particular audio file. For instance, the Associated Description 930 can be stored in Field 932 as pretty/simple/uplifting. The Remarks 940 can be stored in Field 942 as 24003a. Cross references to the Styles fun and Rock can be stored in Field 950, and Extra Information 960 can be stored in Field 970, which in this example identifies the particular artist associated with the licensable audio file titled “Star Smile.”

With respect to the description provided above, it will be evident that there are multiple ways of implementing various aspects of the present invention (e.g., an appropriate API or downloadable software object, etc. which enables applications and services to use the disclosed systems and methods). The invention can be implemented from the standpoint of an API (or other software object), as well as from a software or hardware object that responds to any of the aforementioned techniques. Thus, various implementations described herein may have aspects that are wholly in hardware, partly in hardware and partly in software, as well as in software.

While exemplary embodiments of the present invention have been described in connection with various computing devices and network architectures, the underlying concepts may be applied to any computing device or system. One of ordinary skill in the art will appreciate that there are numerous ways of providing nomenclature that achieves the same, similar or equivalent functionality achieved by the various embodiments of the invention. As mentioned, the various techniques described herein may be implemented in connection with hardware or software or, where appropriate, with a combination of both.

Thus, the techniques and technologies described above and in the claims below, may take the form of program code (i.e., instructions) embodied in tangible media, wherein, the program code is loaded into and executed by a computer. In such cases, the computer becomes an apparatus for practicing the invention.

In other cases, where execution of program code on programmable computers involves a computing device, a computing device generally comprises: a processor, a storage medium readable by the processor (including volatile and non-volatile memory and/or storage elements), and possibly at least one input device, and at least one output device.

One or more programs that may implement or utilize the techniques of the present invention, can be implemented in a high level procedural or object oriented programming language to communicate with a computer system. Alternatively, the program(s) can be implemented in assembly or machine language. In any case, the language may be a compiled or interpreted language, and may combined with hardware implementations.

The techniques and technologies described herein may also be practiced via communications embodied in the form of program code that is transmitted over some transmission medium. When the program code is received (and loaded into and executed by) a machine, such as a client computer, etc., the machine becomes an apparatus for practicing the invention.

While the present invention has been described in connection with the preferred embodiments of the various figures, it is to be understood that other similar embodiments may be used or modifications and additions may be made to the described embodiment for performing the same function of the present invention without deviating therefrom. For example, while exemplary network environments of the invention are described in the context of a networked environment, such as a peer to peer networked environment, one skilled in the art will recognize that the present invention is not limited thereto, and that the methods, as described in the present application may apply to any computing device or environment, whether wired or wireless, and may be applied to any number of such computing devices connected via a communications network, and interacting across the network. Furthermore, it should be emphasized that a variety of computer platforms, and other application specific operating systems are contemplated.

Still further, the present invention may be implemented in or across a plurality of processing chips or devices, and storage may similarly be effected across a plurality of devices.

Therefore, the present invention should not be limited to any single embodiment, but rather should be construed in breadth and scope in accordance with the appended claims.

What is claimed:

1. A web-based method, comprising:
selecting a licensable audio file stored on a storage medium at a server;
loading the licensable audio file into an audio player module;
loading a video file into a video player module coupled to the audio player module by an interface;
auditioning the licensable audio file against the video file;
deciding whether to license/purchase the licensable audio file for use with the video file; and
entering into an agreement to license or purchase the licensable audio file for use with the video file if a prospective licensee/purchaser decides to license or purchase the licensable audio file for use with the video file.

2. A web-based method according to claim 1, wherein the licensable audio file comprises a copyrighted musical composition, and wherein the agreement to license/purchase the licensable audio file for use with the video file comprises:
a synchronization license granting the licensee the right to incorporate the copyrighted musical composition within a commercial production and/or to publicly perform the copyrighted musical composition.

3. A web-based method according to claim 2, wherein the synchronization license grants the licensee the right to use the copyrighted musical composition in combination with visual images in an audio-visual production.

4. A web-based method according to claim 2, wherein the agreement to license/purchase the licensable audio file for use with the video file further comprises:
a master use license granting the licensee the right to incorporate a copyrighted sound recording within any project or production that will be publicly performed, displayed, broadcast, exhibited or reproduced.

5. A web-based method according to claim 2, wherein the agreement to license/purchase the licensable audio file for use with the video file further comprises:
a mechanical license that grants the licensee the rights to reproduce and distribute the copyrighted musical composition.

6. A web-based method according to claim 1, wherein auditioning the licensable audio file against the video file, further comprises:
displaying playback of the licensable audio file on the audio player module;
displaying playback of the video file on the video player module; and
synchronizing the playback of the licensable audio file to the playback of the video file.

7. A web-based method according to claim 1, wherein synchronizing the licensable audio file to the video file, further comprises:
starting playback of the licensable audio file on the audio player module at a first time; and
starting playback of the video file on the video player module at a second start time, wherein the first start time is offset from the second time by a predetermined amount.

8. A web-based method according to claim 7, wherein the predetermined amount comprises a difference between the first start time and the second start time.

9. A web-based method according to claim 8, wherein:
the first start time comprises a first time code, and the second start time comprises an initial start time of the video file; or
the first start time comprises an initial start time of the licensable audio file, and wherein the second start time comprises a second time code.

10. A web-based method according to claim 6, further comprising:
saving the synchronized licensable audio file and video file at the server.

11. A web-based system, comprising:
a server comprising: a first storage medium configured to store a licensable audio file; and
a second storage medium configured to store a video file; and
a Graphical User Interface (GUI) comprising:
a display comprising an audio player user interface (APUI) and a video player user interface (VPUI): and
a user interface selection device designed to allow a user to select the licensable audio file stored on the second storage medium at the server, to load the licensable audio file for playback on the APUI, to load the video file for playback on the VPUI and to audition the licensable audio file against the video file.

12. A web-based system according to claim 11, wherein the APUI is configured to display playback of the licensable audio file, and the VPUI is configured to display playback of the video file.

13. A web-based system according to claim 12, wherein the GUI further comprises:
a synchronization engine configured to synchronize the playback of the licensable audio file to the playback of the video file.

14. A web-based system according to claim 13, wherein the synchronization engine if further configured to start playback of the licensable audio file at a first start time, and to start playback of the video file at a second start time, and wherein the first time is offset from the second time by a predetermined amount.

15. A web-based system according to claim 14, wherein the predetermined amount comprises a difference between the first start time and the second start time.

16. A web-based system according to claim 14, wherein:
the first start time comprises a first time code, and the second start time comprises an initial start time of the video file; or
the first start time comprises an initial start time of the licensable audio file, and the second start time comprises a second time code.

17. A web-based system according to claim 14, wherein the server is configured to:
store the synchronized licensable audio file and video file in response to an indication from a client computer that the synchronized licensable audio file and video file are to be saved.

18. A web-based system according to claim 11, wherein the licensable audio file comprises:
a copyrighted musical composition being offered to a prospective licensee/purchaser for use with the video file.

19. A web-based system according to claim 18, wherein the copyrighted musical composition is being offered to a prospective licensee for:
a synchronization license granting the licensee the right to incorporate the copyrighted musical composition in combination with visual images in an audio-visual production, and a master use license granting the licensee the right to incorporate a copyrighted sound recording within any project or production that will be publicly performed, displayed, broadcast, exhibited or reproduced; or
a mechanical license that grants the licensee the rights to reproduce and distribute the copyrighted musical composition.

20. A Graphical User Interface (GUI), comprising:
an audio player user interface (APUI) configured to display playback of a licensable audio file provided from a server;
a video player user interface (VPUI) configured to display playback of a video file;
a user interface selection device designed to allow a user to:
select the licensable audio file stored at the server, and load the licensable audio file for playback on the APUI,
load the video file for playback on the VPUI, and
audition the licensable audio file against the video file; and
a synchronization engine configured to synchronize the playback of the licensable audio file to the playback of the video file by starting the playback of the licensable audio file at a first time and starting the playback of the video file at a second time, and wherein the first time is offset from the second time by a predetermined amount.
